(19) United States
(12) Patent Application Publication
(10) Pub. No.: US 2017/0214020 A1
(43) Pub. Date: Jul. 27, 2017

(54) SEPARATOR FOR NONAQUEOUS ELECTROLYTE SECONDARY BATTERY

(71) Applicant: Samsung Electronics Co., Ltd., Suwon-si (KR)

(72) Inventors: Yoshitaka YAMAGUCHI, Kanagawa (JP); Mitsuharu KIMURA, Kanagawa (JP); Hironari TAKASE, Kanagawa (JP); Ryo IWAMURO, Kanagawa (JP)

(21) Appl. No.: 15/412,833

(22) Filed: Jan. 23, 2017

(30) Foreign Application Priority Data
Jan. 22, 2016 (JP) 2016-010568
Aug. 31, 2016 (KR) 10-2016-0111684
Sep. 1, 2016 (JP) 2016-170907
Nov. 9, 2016 (JP) 2016-219226
Jan. 10, 2017 (KR) 10-2017-0003398

(51) Int. Cl. H01M 2/16; H01M 10/0525; B29C 70/10; H01M 2/14

(52) U.S. Cl. CPC H01M 2/1626; H01M 2/145; H01M 10/0525; B29C 70/10; B29K 2083/00

(57) ABSTRACT

A separator for a nonaqueous secondary battery includes a plurality of cellulose nanofibers and a hydroxyl group-masking component for masking hydroxyl groups on a surface of the cellulose nanofibers, wherein the cellulose nanofibers are cross-linked by the hydroxyl group-masking component to form a nonwoven fabric; as well as a nonaqueous electrolyte secondary battery including the separator, and a method of preparing the separator.

### CROSS-REFERENCE TO RELATED APPLICATIONS

This application claims the benefits of Japanese Patent Application No. 2016-010568, filed on Jan. 22, 2016, Japanese Patent Application No. 2016-170907, filed on Sep. 1, 2016, and Japanese Patent Application No. 2016-219226, filed on Nov. 9, 2016, in the Japan Patent Office; and Korean Patent Application No. 10-2016-0111684, filed on Aug. 31, 2016, and Korean Patent Application No. 10-2017-0003398, filed on Jan. 10, 2017, in the Korean Intellectual Property Office, the entire disclosures of which are hereby incorporated by reference.

### BACKGROUND

1. Field

The present disclosure relates to a separator for a nonaqueous electrolyte secondary battery, a nonaqueous electrolyte secondary battery including the same, and a method of preparing the separator.

2. Description of the Related Art

A separator is used in a nonaqueous electrolyte secondary battery, such as a lithium ion battery, to separate a positive electrode from a negative electrode in order to prevent short circuits in the battery. Such a separator should have fundamental characteristics including resistance to an electrolytic solution and low internal resistance. In addition, when a nonaqueous electrolyte secondary battery is used in an automobile or the like, a separator of the nonaqueous electrolyte secondary battery should also have heat resistance.

A nonwoven fabric made of polyolefin, such as polyethylene or polypropylene, has been widely used as a separator for a nonaqueous electrolyte secondary battery. However, when a separator is used in a battery for an automobile, the separator is required to have a heat resistance temperature of 200° C. or greater, and thus, use of a separator made of polyolefin is not appropriate.

A cellulose nonwoven fabric may have utility in manufacturing a separator having high heat resistance. More particularly, studies have been conducted to obtain a separator having excellent electrical characteristics by using cellulose nanofibers with an average fiber diameter of 1 μm or less (see JP 2006-049797).

However, such a cellulose nonwoven fabric has a low strength. A typical nonwoven fabric is made up of cellulose fibers that are linked with each other through hydrogen bonds, has a lower strength than a polyolefin-based nonwoven fabric, and is difficult to handle. Thus, to improve the strength of a separator cellulose nanofiber separator, use of a binder consisting of a hydrophilic polymer including a carboxyl group or a hydroxyl group has been studied (see JP 2006-049797).

However, in addition to having a low strength, a separator including cellulose nanofibers also has a low withstand voltage. One of the reasons why the separator including cellulose nanofibers has a low withstand voltage is that a hydroxyl groups present on a cellulose surface are not electrochemically stable. In particular, to increase a specific capacity of an electrode active material, a battery has been recently required to be charged with a voltage of 4.3 V or more. However, since cellulose nanofibers include a number of hydroxyl groups, hydroxyl groups exposed on surfaces of cellulose nanofibers undergo degradation due to the increased charging voltage, which causes deterioration of a battery. According to JP 2003-123724, a method of esterifying hydroxyl groups has been studied, but sufficient effects have not been obtained yet.

Therefore, there is a need for a nonaqueous electrolyte secondary battery separator with improved strength and voltage..

### SUMMARY

Provided is a separator for a nonaqueous electrolyte secondary battery, the separator that has high strength and withstand voltage.

Also provided is a nonaqueous electrolyte secondary battery including the separator, and a method of preparing the separator and battery.

Additional aspects will be set forth in part in the description which follows and, in part, will be apparent from the detailed description.

According to an aspect of an example embodiment, the separator for a nonaqueous electrolyte secondary battery includes:

a plurality of cellulose nanofibers; and

a hydroxyl group-masking component for masking a hydroxyl group on a surface of the cellulose nanofibers,

wherein the cellulose nanofibers are mutually bonded by the hydroxyl group-masking component to form a nonwoven fabric.

In another embodiment, the hydroxyl group-masking component includes a cross-linking agent that is linked with a hydroxyl group of the cellulose nanofibers thereby cross-linking the cellulose nanofibers.

The cross-linking agent can include at least one main component selected from aluminum and boron. For example, the cross-linking agent includes at least one of an organic aluminum-containing compound and an organic boron-containing compound. Optionally, the amount of the cross-linking agent is in a range of about 0.01 parts by weight to about 0.21 parts by weight with respect to 100 parts by weight of the cellulose nanofibers (i.e. 0.01 to 0.21 weight percent with respect to the cellulose nanofibers).

Optionally, the hydroxyl group-masking component includes a binder resin that coats a surface of the cellulose nanofibers. For example, the binder resin can be a water-dispersible polyvinylidene fluoride resin. The amount of the binder resin can be in a range of about 1 part by weight to about 80 parts by weight with respect to 100 parts by weight of the cellulose nanofibers, and porosity of the nonwoven fabric can be about 30% or more.

In an embodiment, the hydroxyl group-masking component comprises a silane cross-linking agent including a first amine group. For example, the silane cross-linking agent can be represented by NH₂—R—S—(OH)₃ in a hydrolyzed state, wherein R is a substituted or unsubstituted C₁-C₆ alkyl group. For instance, R can be (CH₂)ₙ(NH)ₘ (where 3≦n+m≦6). Optionally, the silane cross-linking agent can be present in an amount of about 5 weight % to about 40 weight % with respect to the cellulose nanofibers, and the porosity of the nonwoven fabric can be about 40% or more and/or about 80% or less.

In an example embodiment, the amount of cellulose nanofibers having an average fiber diameter of less than about 1 μm in the cellulose nanofibers is about 90 weight % or more (e.g., about 95 wt % or more, or substantially all or all nanofibers, have an average fiber diameter of less than about 1 μm).

According to yet another embodiment, a method of preparing the separator includes:

producting a nonwoven fabric by using a deposition solution containing a plurality of cellulose nanofibers and an aqueous hole-opening agent; and

masking a hydroxyl group on a surface of the cellulose nanofibers of the nonwoven fabric.

In an embodiment, the masking of the hydroxyl group includes impregnating the nonwoven fabric with a solution containing a cross-linking agent,

wherein the cross-linking agent includes at least one component selected from aluminum and boron,

wherein the main component is linked with a hydroxyl group of the cellulose nanofibers to mask the hydroxyl group and allow cross-linking of the cellulose nanofibers. Optionally, the cross-linking agent can include at least one of an organic aluminum-containing compound and an organic boron-containing compound. Optionally, the cross-linking agent includes at least one of aluminum sulfate, aluminum oxysalt, boron sulfate, and boron oxysalt. Optionally, an amount of the cross-linking agent is in a range of about 0.01 parts by weight to about 0.21 parts by weight with respect to 100 parts by weight of the cellulose nanofibers. Optionally, a solution containing the cross-linking agent (also referred to as a cross-linking agent solution) includes an aqueous hole-opening agent.

In an embodiment, the deposition solution includes fine particles of the binder resin having water dispersibility, and

the masking of the hydroxyl group includes heating the nonwoven fabric at a temperature higher than a softening point of the binder resin,

wherein the binder resin coats a surface of the cellulose nanofibers to mask the hydroxyl group on the cellulose nanofibers and cross-links the cellulose nanofibers. Optionally, the binder resin is a water-dispersible polyvinylidene fluoride resin. Optionally, an amount of the fine particles of the binder resin in the deposition solution is in a range of about 1 part by weight to about 80 parts by weight with respect to 100 parts by weight of the cellulose nanofibers. For example, an average particle diameter of the fine particles of the binder resin is in a range of about 0.01 μm to about 1 μm.

Optionally, before performing the heating of the nonwoven fabric at a temperature higher than a softening point of the binder resin, the aqueous hole-opening agent in the nonwoven fabric is removed. For example, the aqueous hole-opening agent in the nonwoven fabric is removed by heating or washing

Optionally, a volumetric proportion of the aqueous hole-opening agent in the deposition solution is greater than that of the fine particles of the binder resin. For example, an amount of the aqueous hole-opening agent in the deposition solution is in a range of about 5 parts by weight to about 1,000 parts by weight with respect to 100 parts by weight of the cellulose nanofibers.

In an example embodiment, the masking of the hydroxyl group includes impregnating the nonwoven fabric with a cross-linking agent solution containing a silane cross-linking agent including a first amine group, and heating the impregnated nonwoven fabric. For example, the silane cross-linking agent including is represented by NH₂—R—S—(OH)₃ in a hydrolyzed state, wherein R is a substituted or unsubstituted C₁-C₆ alkyl group, and for example, R is (CH₂)ₙ(NH)ₘ (where 3≦n+m≦6).

In an example embodiment, the cross-linking agent solution includes an aqueous hole-opening agent.

In an example embodiment, an amount of fibers having an average fiber diameter of less than about 1 μm in the cellulose nanofibers is about 90 weight % or more.

### BRIEF DESCRIPTION OF THE DRAWINGS

These and/or other aspects will become apparent and more readily appreciated from the following description of the example embodiments, taken in conjunction with the accompanying drawing in which:

FIG. 1 is a spectrum showing the results of infrared total reflection absorption measurements on cross-linked nonwoven fabrics prepared according to Examples 1 to 3 and Comparative Examples 1 and 2;

FIG. 2 is an electron microscopic image showing a cross-linked nonwoven fabric prepared according to Example 19;

FIG. 3 is an electron microscopic image showing a cross-linked nonwoven fabric prepared according to Comparative Example 4;

FIG. 4 is an electron microscopic image showing a cross-linked nonwoven fabric prepared according to Comparative Example 5;

FIGS. 5A and 5B show X-ray spectroscopic measurements on a cross-linked nonwoven fabric prepared according to Example 19;

FIGS. 6A, 6B, and 6C show element mapping results on a cross-linked nonwoven fabric prepared according to Example 19;

FIGS. 7A and 7B show X-ray spectroscopic measurements on a cross-linked nonwoven fabric prepared according to Comparative Example 5;

FIGS. 8A and 8B are electron microscopic images each showing a nonwoven fabric in a state before (FIG. 8A) and after (FIG. 8B) performing cross-linking thereon according to Example 21; and

FIGS. 9A and 9B are spectrum images each showing results of infrared absorption measurements on a nonwoven fabric in a state before (FIG. 9A) and after (FIG. 9B) performing cross-linking thereon according to Example 21.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

Hereinafter, a separator for a nonaqueous electrolyte secondary battery according to example embodiments, a separator for a nonaqueous electrolyte secondary battery can be used in a lithium ion battery.

According to an illustrative embodiment, a separator for a nonaqueous electrolyte secondary battery may include a plurality of cellulose nanofibers and a hydroxyl group-masking component for masking a hydroxyl group on a surface of the cellulose nanofibers, wherein the cellulose nanofibers are mutually bonded (i.e., crosslinked) by the hydroxyl group-masking component to form a nonwoven fabric.

Due to the hydroxyl group-masking component, a withstand voltage of the separator may improve. The hydroxyl group-masking component may be linked with the hydroxyl group of the cellulose nanofibers. The hydroxyl group-masking component can include a cross-linking agent that allows cross-linking of the cellulose nanofibers. The cross-linking agent may include at least one component selected from aluminum and boron. The main component may be linked with the hydroxyl group of the cellulose nanofibers so that the cellulose nanofibers are cross-linked with each other.

The cellulose nanofibers may becan be nanosized cellulose fibers. As used herein, a “nanofiber” is a fiber having a diameter of about 2 μm or less (e.g., about 1 μm or less), or a plurality of fibers having an average fiber diameter of 2 μm or less (e.g., about 1 μm or less). Examples of the cellulose nanofibers include fibers prepared by performing fibrillation and refining on natural cellulose fibers, such as pulp, or regenerated cellulose fibers, fibers prepared by refining cellulose derived from purified linter or ascidiacea, and bacteria cellulose produced by cellulose-producing microorganisms. Among these examples, use of fibers prepared by performing fibrillation and refining on natural cellulose fibers can be advantageous in terms of ease of acquisition.

In an example embodiment, the cellulose nanofibers may have an average fiber diameter in a range of about 20 nm to about 300 nm. In some embodiments, the separator is substantially or completely free of fibers having an average fiber diameter of 1 μm or more. For example, in some embodiments, at least about 90 weight % or about 95 weight % of the cellulose nanofibers have an average fiber diameter of less than about 1 μm. In addition or instead, at least about 80 wt.% of the cellulose nanofibers have an average fiber diameter of about 500 nm or less. As such, when the cellulose nanofibers include no more than a small amount of fibers having a large average fiber diameter, a thickness, a pore size, and Gurley permeability of the separator can be easily controlled during deposition. In addition, the fiber diameter of the cellulose nanofibers can be measured by observing conditions of the separator or by observing cellulose fibers prepared by casting, depositing, and drying a dilution solution, via a transmission electron microscope (TEM) and a scanning electron microscope. For example, the viscosity of cellulose fiber aqueous suspensions having an amount in a range of about 0.1 weight % to about 2 weight % (measured by using an E type or B type viscometer), the tensile strength of the cellulose fiber aqueous suspensions, and the surface area of the nonwoven fabric can be comprehensively evaluated to thereby calculate the amount fibers having an average fiber diameter of less than about 1 μm (refer to WO2013/054884).

The cross-linking agent may include, as a main component, an aluminum-including compound or a boron-including compound to facilitate formation of an ionic bond with a hydroxyl group of the cellulose nanofibers. For example, the main component may include an inorganic compound that is easily ionizable in water or an organic compound that is easily hydrolyzable in water. As used herein, a “main component” is a component having 50 weight percent or greater with respect to the cross-linking agent.

In an embodiment, the cross-linking agent may include at least one of an aqueous inorganic salt and a hydrolyzable organic compound.

In various embodiments, the cross-linking agent may include a metallic salt including a polycation and an anion, or a non-metallic salt. The cross-linking agent may include at least one selected from aluminum sulfate, aluminum oxysalt, boron sulfate, and boron oxysalt. Examples of the cross-linking agent include aluminum sulfate (Al₂(SO₄)₃), sodium aluminate (NaAlO₂), boron sulfate (B₂(SO₄)₃), and boric acid (B(OH)₃), but exemplary embodiments are not limited thereto.

In various embodiments, the cross-linking agent may include at least one of an aluminum-including compound and a boron-including compound.

For example, the cross-linking agent may include at least one of an aluminum-including compound and a boron-including compound that are each independently represented by one selected from formulae (1) to (5), but example embodiments are not limited thereto:

MR(OH)₂ (1)

(HO)₂M-M(OH)₂ (2)

(RO)₂M-O-M(OR)₂ (3)

M(O(C═O)R′ (4)

M(OH)₃₋ₓ(OR′C(═O)O)ₓ (5).

In formulae (1) to (5), M indicates aluminum or boron, R indicates hydrogen, a linear or branched C₁-C₈ alkyl group, or a C₃-C₈ cycloalkyl group, R′ indicates a linear or branched C₂-C₄ alkyl group, an oxygen-containing glycol ether group, or a diol group, and 1≦x≦3.

Regarding the expression “Cₐ-C_{b}” used herein, a and b each indicate the number of carbon atoms of a specific functional group. That is, a functional group may include carbon atoms in the number of a to b. For example, a “C₁-C₄ alkyl group” may refer to an alkyl group having 1 to 4 carbon atom(s), and examples thereof include CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

The term “alkyl group” used herein refers to a branched or unbranched aliphatic hydrocarbon group. In detail, a “linear alkyl group” may refer to an unbranched aliphatic hydrocarbon group, and a “branched alkyl group” may refer to a branched aliphatic hydrocarbon group. In an certain embodiments, the alkyl group can be or may not be substituted. Examples of the alkyl group include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, and a cycloheptyl group, but example embodiments are not limited thereto. Each of the examples of the alkyl group can be or may not be optionally substituted. In ancertain embodiments, the alkyl group may have 1 to 8 carbon atom(s). Examples of a C₁-C₈ alkyl group include a methyl group, an ethyl group, a propyl group, an isopropyl group, a butyl group, an isobutyl group, a sec-butyl group, a pentyl group, a 3-pentyl group, a hexyl group, a heptyl group, and an octyl group, but example embodiments are not limited thereto.

The term “cycloalkyl group” used herein may refer to a fully saturated carbocyclic ring or ring system. Examples of the C₃-C₈ cycloalkyl group include a cyclopropyl group, a cyclobutyl group, a cyclopentyl group, a cyclohexyl group, a cycloheptyl group, and a cyclooctyl group.

Examples of the aluminum-including compound or the boron-including compound include aluminum isopropoxide, aluminum sec-butoxide, hydroxyl aluminum bis(2-ethylhexanoate), aluminum 2-ethylhexanoate, ethyl(tri-sec-butoxy)dialuminum, ethylboric acid, butylboric acid, n-octylboric acid, cyclohexylboric acid, tetrahydroxyboric acid, boric acid tripropyl, boric acid tributyl, boric acid triisopropyl, ethoxyboric acid pinacol, bis(4,4,5,5-tetramethyl-1,3,2-dioxaborolane-2-yl)methane, bis(neopentyl glycolato)diboron, and bis(hexylene glycolato)diborane, but example embodiments are not limited thereto.

The compounds above can be used alone or in combination. For example, two or more inorganic compounds can be used in combination, two or more organic compounds can be used in combination, one or more inorganic compound(s) and one or more organic compound(s) can be used in combination. In an embodiment, the aluminum-including compound and the boron-including compound are used in combination.

The main component of the cross-linking agent, i.e., aluminum and boron, can be linked with a hydroxyl group of the cellulose nanofibers. Thus, a hydroxyl group of the cellulose nanofibers, i.e., a hydroxyl group exposed on surfaces of the cellulose nanofibers, can be linked with aluminum or boron, which is the main component of the cross-linking agent, thereby being subjected to masking using aluminum or boron. The term “masking” used herein may refer to a method of capping or blocking a functional group of a compound by using a predetermined masking agent in terms of protection from the outside. That is, in the present inventive concept, it can be understood that the hydroxyl group of e the cellulose nanofibers is protected by aluminum or boron from the outside.

In addition, since one aluminum atom or one boron atom can be linked with one or more hydroxyl group(s), aluminum or boron can be linked with neighboring cellulose nanofibers.

Therefore, the separator according to an example embodiment may the cellulose nanofibers that are mutually bonded (i.e., covalently cross-linked) with each other via aluminum or boron. In this regard, as compared with cellulose nanofibers in the related art that are linked with each through hydrogen bonds between hydroxyl groups of the cellulose nanofibers, the separator of the present inventive concept may have a significantly great tensile strength.

In addition, when the cross-linking agent including aluminum or boron as the main component is not used, free hydroxyl groups that are not involved in the hydrogen bonds between the cellulose nanofibers may exist on surfaces of the cellulose nanofibers. Since such free hydroxyl groups can be readily degraded during charging of a battery, a battery including such free hydroxyl groups may have significantly decreased capacity retention rates during charging of the battery until a voltage thereof reaches about 4.3 V. However, the separator according to the present inventive concept includes hydroxyl groups that are masked with aluminum or boron, the hydroxyl groups are not readily degraded, and thus a battery including the separator according to the present inventive concept may exhibit high capacity retention rates during charging of the battery until a voltage thereof reached about 4.3 V. For example, when the battery is charged until a voltage thereof reaches about 4.4 V, the battery may exhibit capacity retention rates of 70% or more.

In an embodiment, the separator of the present inventive concept is prepared by casting a mixture of cellulose nanofibers and an aqueous hole-opening agent. In detail, first, a deposition solution in which an aqueous hole-opening agent is added to a water suspension of cellulose nanofibers can be prepared. Afterwards, a flat surface can be coated with the deposition solution, and then, dried to form a nonwoven fabric (porous film). The nonwoven fabric can be then washed to remove the hole-opening agent by drying. The dried nonwoven fabric can be soaked in a solution containing a cross-linking agent, and then, dried by heating while a cross-linking reaction occurs in the nonwoven fabric.

The concentration of the cellulose nanofibers in the deposition solution can be appropriately controlled according to deposition methods. As a solvent in the deposition solution, water can be used due to ease of handling and low cost. However, a solvent having a higher vapor pressure than water may also be used.

As the aqueous hole-opening agent, an agent widely known in the art can be used. Examples of the aqueous hole-opening agent include: higher alcohol-based agents, such as 1,5-pentanediol and 1-methylamino-2,3-propanediol; lactone-based agents, such as ε-caprolactone and α-acetyl-γ-butyrolactone; glycol-based agents, such as diethylene glycol, 1,3-butylene glycol, and propylene glycol; glycol ether-based agents, such as triethylene glycol dimethyl ether, tripropylene glycol dimethyl ether, diethylene glycol monobutyl ether, triethylene monomethyl ether, triethylene glycol butylmethyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, ethylene glycol monoisopropyl ether, ethylene glycol monoisomutyl ether, tripropylene glycol monomethyl ether, diethylene glycol methylethyl ether, and diethylene glycol diethyl ether; glycerin; carbonated propylene; and N-methyl pyrrolidone. For example, the aqueous hole-opening agent can be triethylene glycol butylmethyl ether.

The amount of the aqueous hole-opening agent to be added to the deposition solution can be controlled according to properties of a desired film. However, to secure hole openings necessary in the separator, the amount of the aqueous hole-opening agent can be, based on 100 parts by weight of the cellulose nanofibers, about 5 parts by weight or greater, about 50 parts by weight or greater, about 100 parts by weight or greater. In an example embodiment, the amount of the aqueous hole-opening agent can be, based on 100 parts by weight of the cellulose nanofibers, about 3,000 parts by weight or less, about 1,000 parts by weight or less, about 500 parts by weight or less, or about 300 parts by weight or less.

The coating of the solution containing the cellulose nanofibers can be a known method in the art. For example, a flat surface can be coated with the solution containing the cellulose nanofibers by using a slot die coater, a cotton coater, an MB coater, an MB-reverse coater, or an MB comma coater.

Regarding conditions for drying the casting solution in terms of sufficiently reducing residual amounts of the solvent and the aqueous hole-opening agent, a temperature at which the drying of the casting solution is performed can be about 50° C. or more, and for example, can be 60° C. or more. To prevent the occurrence of deterioration of the cellulose nanofibers, the temperature at which the drying of the casting solution is performed can be about 200° C. or less, and for example, can be about 150° C. or less or about 120° C. or less. The drying of the casting solution can be performed by using a heater or through infrared irradiation or hot-air. In addition, the drying of the casting solution can be performed at a reduced pressure.

In an example embodiment, a nonwoven fabric can be formed by evaporation of water and the aqueous hole-opening agent, and then, the nonwoven fabric can be washed with an organic solvent. The organic solvent is not particularly limited, but an organic solvent having a relatively fast volatilization speed, such as toluene, acetone, methyl ethyl ketone, ethyl acetate, n-hexane, and propanol, can be used alone or in a mixture thereof. Here, the organic solvent can be used once or several times. For use of washing the residual hole-opening agent, a solvent having high affinity for water, such as ethanol or methanol, can be used. However, due to conversion of moisture of a coating substrate into a solvent or absorption of moisture in the air, a property of a sheet shape of a cellulose nano-nonwoven fabric can be affected. In this regard, a condition in which the water amount is controlled can be preferable. A solvent having high hydrophobicity, such as n-hexane or toluene, has a disadvantage of poor effect of washing a hydrophilic hole-opening agent. However, such a solvent can be appropriately used to make it difficult to absorb moisture. In this regard, the washing can be repeated while changing types of the solvent to gradually increase hydrophobicity thereof. For example, the washing can be performed by using acetone, toluene, and n-hexane in this stated order.

As described above, the cross-linking agent may include at least one of an aqueous inorganic salt and a hydrolyzable organic compound. In an example embodiment, the cross-linking agent may include at least one selected from aluminum sulfate, aluminum oxysalt, boron sulfate, and boron oxysalt. For example, the cross-linking agent may include at least one of an organic aluminum-containing compound and an organic boron-containing compound, but example embodiments are not limited thereto.

The cross-linking agent solution can be a solution containing the aluminum-containing compound or the boron-containing compound, as described above. The concentration of the cross-linking agent can be controlled according to properties of a desired film and types of the cross-linking agent. However, to simultaneously improve a strength of the film and increase a withstand voltage of the masked hydroxyl group, the concentration of the cross-linking agent in the nonwoven fabric can be, based on 100 parts by weight of the cellulose nanofibers, about 0.01 parts by weight or more, for example, about 0.015 parts by weight or more, or about 0.02 parts by weight or more. In addition, to maintain porosity of the nonwoven fabric, the concentration of the cross-linking agent in the nonwoven fabric can be about 0.21 parts by weight or less, for example, about 0.2 parts by weight or less or about 0.18 parts by weight or less. For example, for use as the cross-linking agent having the concentration within the ranges above, the concentration of the cross-linking agent in a cross-linking process performed on the nonwoven fabric can be controlled to be in a range of about 0.01 weight % to about 0.2 weight % with respect to the cellulose nanofibers.

In the finally obtained separators, the amount of cross-linking agent can be measured as follows: the nonwoven fabric is stored in a room with low humidity (dew point: −30° C.) for 3 days, dried, and then, cut into an A4 size, and a difference between a weight of the nonwoven fabric and a weight of an untreated nonwoven fabric is measured by comparing the weights by micro-electronic scale or the like. In an example embodiment, the amount of cross-linking agent can be measured according to an inductively coupled plasma mass spectrometry (ICP-MA) analysis or an inductively coupled plasma-atomic emission spectrometry (ICP-AES) analysis, after boiling the nonwoven fabric in an aqueous solution of hydrochloric acid and nitric acid (1:1) to extract aluminum and boron.

A solvent used in the solution containing the cross-linking agent can be selected according to types of the cross-linking agent. For example, when the cross-linking agent is an inorganic salt, water can be used as a solvent. In addition, when the cross-linking agent is an organic compound, an organic solvent can be used. If necessary, a mixture of water and an organic solvent can be used, or a mixture of several organic solvents can be used.

A temperature at which the solution containing the cross-linking agent is dried can be controlled according to types of a solvent. However, in consideration of sufficient cross-linking reactions and sufficient reduction of the residual amount of the solvent, the temperature can be 50° C. or greater, for example, about 60° C. or greater. In addition, to prevent deterioration of the cellulose nanofibers, the temperature can be about 200° C. or less, for example, about 150° C. or less or about 120° C. or less. The drying of the solution containing the cross-linking agent can be performed by using a heater or through infrared irradiation or hot-air. In addition, the drying of the solution containing the cross-linking agent can be performed at a reduced pressure.

In example embodiment, the nonwoven fabric undergone the cross-linking reaction may undergo a washing process by using an organic solvent. The organic solvent is not particularly limited, and an example thereof includes toluene.

In various example embodiments, the nonwoven fabric undergone the cross-linking reaction can be pressed. As such, the pressed nonwoven fabric after treatments with the cross-linking reaction and the drying may provide the nonwoven fabric surface smoothness, or may control the nonwoven fabric in terms of porosity. A pressure when pressing the nonwoven fabric can be controlled according to a property of a desired film, but can be in a range of about 2 MPa to about 50 MPa.

In an embodiment, the deposition solution may include a cellulose derivative, such as an alkali salt or ammonium salt of carboxymethyl cellulose, methylhydroxyethyl cellulose, hydroxypropyl cellulose, or hydroxypropylcethyl cellulose. The addition of the cellulose derivative may lead to further improvement of the strength of the film. In addition, regarding the addition of the cellulose derivative, an amount of the binder can be about 1 part by weight or more based on 100 parts by weight of the cellulose nanofibers in consideration of the improvement of the strength of the film, or can be about 2 parts by weight or less based on 100 parts by weight of the cellulose nanofibers in consideration of the maintenance of flexibility of the film.

In an embodiment, the aqueous hole-opening agent is added to the solution containing the cross-linking agent. Upon the addition of the aqueous hole-opening agent, the nonwoven fabric may easily maintain the porosity thereof and can be cross-linked. When the aqueous hole-opening agent is added to the solution containing the cross-linking agent, an amount of the aqueous hole-opening agent can be in a range of about 100 parts by weight to about 600 parts by weight based on 100 parts by weight of the cellulose nanofibers.

After being cross-linked, the nonwoven fabric may have holes having a pore diameter of about 2 μm or less so that short circuits do not occur when fabricating or charging a battery. In addition, the porosity of the nonwoven fabric can be controlled according to a property of a desired separator, but in an example embodiment, the nonwoven fabric may have the porosity in a range of about 30% to about 60% and have Gurley permeability of about 700 seconds/100 mL or less, about 600 seconds/100 mL or less, or about 300 seconds/100 mL or less. In addition, the pore diameter can be measured by a mercury indentation method or a bubble point method. The pore diameter can be also calculated based on a specific gravity and density of the porous cellulose nanofibers. The Gurley permeability of the nonwoven fabric can be obtained by measurement according to JISP8117.

After being cross-linked, a thickness of the nonwoven fabric can be controlled according to a property of a desired separator. However, in order to increase insulation and ease of fabrication, the thickness of the nonwoven fabric can be about 10 μm or greater, for example, about 14 μm or greater. In addition, in consideration of ionic conduction between a positive electrode and a negative electrode, the thickness of the nonwoven fabric can be about 25 μm or less, for example, about 20 μm or less. In addition, the thickness can be measured using a micrometer.

After being cross-linked, the nonwoven fabric, i.e., the separator for the nonaqueous electrolyte secondary battery, may have a tensile strength of about 200 kgf/cm² or greater, for example, about 250 kgf/cm² or greater or about 300 kgf/cm² or greater, in consideration of a strength required for the separator. The nonwoven fabric having a high tensile strength can be preferable, but in consideration of a winding property, slit property, and porosity, the nonwoven fabric may have a tensile strength of about 1,200 kgf/cm² or less. In addition, the tensile strength can be measured according to the tensile test.

After being cross-linked, a peak strength of the nonwoven fabric, i.e., the cross-linked separator for the nonaqueous electrolyte secondary battery, can be about 50% or less than a non-cross-linked separator at 3,300 cm⁻¹ in an ATR spectrum.

After being cross-linked, the amount of fibers having an average fiber diameter of less than about 1 μm in the nonwoven fabric, i.e., the separator for the nonaqueous electrolyte secondary battery, can be at least 90 weight %.

After being cross-linked, the nonwoven fabric having a small amount of impurities can be preferred in consideration of the separator performance. For example, an amount of sodium in the separator can be less than about 1 ppm. For example, an amount of moisture in the separator can be less than about 1,000 ppm, for example, less than about 300 ppm. For example, an amount of the residual aqueous hole-opening agents in the separator can be less than about 500 ppm. In addition, the separator may include, other than boron, a halogen in a minimum amount. Components included in the electrolytic solution can be also included in the separator an in irrelevant manner. In addition, in terms of elimination of static electricity or the like, quaternary ammonium salt, phosphonium salt, or a pyrrolidinium salt of a fluorine-containing organic acid, such as bis(trifluoromethane sulfonium)amine, can be added to the solution containing the cross-linking agent, thereby being included in the separator.

As the cross-linking agent, a compound including at least one of aluminum and boron can be used. However, in an example embodiment, a silane cross-linking agent including a functional group that is capable of masking a hydroxyl group can be further used as the cross-linking agent. For example, a silane cross-linking agent including a first amine group can be used. Here, a silanol group of the silane cross-linking agent can be chemically bonded to the hydroxyl group of the cellulose nanofibers, and the first amine group of the silane cross-linking agent may form a hydrogen bond with another first amine group or with the hydroxyl group of the cellulose nanofibers. In this regard, the silane cross-linking agent can be capable of masking the hydroxyl group of the cellulose nanofibers while allowing cross-linking of the cellulose nanofibers. In addition, through the formation of a condensed polymer by a siloxane bond between the silanol groups of the silane cross-linking agent, the bonding between the cellulose nanofibers can be further strengthened.

As the silane cross-linking agent including the first amine group, an organic silane compound represented by NH₂—R—Si—(OH)₃ in a hydrolyzed state can be used, wherein R is a substituted or unsubstituted alkyl group, such as a substituted or unsubstituted C₁-C₆ alkyl group. Examples of a substituent that can be substituted for R include an amine group, a C₁-C₅ alkyl group, an aryl group (for example, a phenyl group), and a carbonyl group. For example, R can be (CH₂)ₙ(NH), (where 3≦n+m≦6).

To improve the strength of the film and the withstand voltage of the masked hydroxyl group at the same time, an amount of the silane cross-linking agent in the separator made of the cross-linked nonwoven fabric with respect to the cellulose nanofibers can be about 5 weight % or more, or about 8 weight % or more. In addition, considering the suppression of the problem that the strength of the separator can be lowered in the case of using an excess amount of the silane cross-linking agent, the amount of the silane cross-linking agent can be about 40 weight % or less, about 35 weight % or less, or about 30 weight % or less, with respect to the cellulose nanofibers. A concentration of the silane cross-linking agent in the cross-linked nonwoven fabric can be obtained by comparison of the mass of the nonwoven fabric before and after the cross-linking treatment.

The separator according to an example embodiment can be, for example, prepared as follows. First, a uncross-linked nonwoven fabric made of cellulose nanofibers can be prepared. The uncross-linked nonwoven fabric can be prepared in the same manner as in preparing a nonwoven fabric including, as a cross-linking agent, an aluminum-containing compound or a boron-containing compound. The prepared uncross-linked nonwoven fabric can be then dipped in a cross-linking agent solution containing a silane cross-linking agent, followed by being heated to allow a cross-linking reaction therein. Here, condensation of the silane cross-linking agent may occur. Afterwards, through washing of the resultant product with a solvent, removing of the unreacted silane cross-linking agent, and drying of the resultant product, a cross-linked nonwoven fabric can be obtained.

As the solvent used in the cross-linking agent solution, water or a mixture of water and alcohol can be used in consideration of the production of silanol groups by hydrolysis of an alkoxy group of the silane cross-linking agent. A concentration of the silane cross-linking agent in the cross-linking agent solution can be about 0.1 weight % or more, or in consideration of the prevention of aggregation, can be about 4 weight % or less.

The cross-linking agent solution may include an aqueous hole-opening agent as needed. When the aqueous hole-opening agent is added, a concentration of the aqueous hole-opening agent in the cross-linking agent solution can be in a range of about 6 g/100 mL to about 12.5 g/100 mL.

A heating temperature for the cross-linking reaction may vary depending on types of the silane cross-linking agent being used, but in consideration of a sufficient cross-linking process and condensation, the heating temperature can be about 60° C. or higher, about 80° C. or higher, or about 100° C. or higher. In addition, in consideration of the prevention of deterioration of the nanofibers, the heating temperature can be about 200° C. or less, about 150° C. or less, or about 120° C. or less. The time required for the heating can be, in consideration of a sufficient cross-linking process and condensation, about 15 minutes or more, or about 30 minutes or more. In addition, in consideration of the prevention of deterioration and energy efficiency, the heating time can be about 5 hours or less or about 3 hours or less.

The washing in terms of removing the unreacted silane cross-linking agent can be performed by using alcohol, in consideration of the solubility and ease of drying of the silane cross-linking agent. The drying following the washing can be performed differently depending on types of a solvent used in the washing. For example, when ethanol is used, the drying can be performed at a temperature in a range of about 60° C. to about 100° C.

A property of the separator according to an example embodiment can be the same as a separator including, as a cross-linking agent, an aluminum-containing compound or a boron-containing compound. The separator according to an example embodiment may have a tensile strength of about 400 kgf/cm² or more or about 500 kgf/cm² or more, and porosity in a range of about 60% to about 80%.

In an example embodiment, the hydroxyl group-masking component may include a cross-linking agent that is linked with the hydroxyl group of the cellulose nanofibers to allow cross-linking of the cellulose nanofibers, but in various example embodiments, the hydroxyl group-masking component may include a binder resin that cotes a surface of the cellulose nanofibers.

In an example embodiment, the binder resin may not be fine particles, and may coat the surface of the cellulose nanofibers. In this regard, the binder resin may not only generate the bonding between the cellulose nanofibers, but also serve as the hydroxyl group-masking component for masking the hydroxyl group on the surface of the cellulose nanofibers. Accordingly, the nonwoven fabric may have an improved strength and exhibit an improved withstand voltage. In the case of a nonwoven fabric in which the cellulose nanofibers are bonded to the fine particles of the binder resin rather than being coated by the binder resin, such a nonwoven fabric may have an improved strength. However, since the hydroxyl group on the cellulose nanofibers is hardly affected, an improved withstand voltage may not be expected.

Considering the improvement of the withstand voltage, the hydroxyl groups on the surfaces of the cellulose nanofibers that are entirely coated by the binder resin can be all masked. However, considering the productivity, only a part of the surfaces of the cellulose nanofibers can be coated while other parts of the surfaces of the cellulose nanofibers may remain without being coated.

The separator according to an example embodiment can be, for example, prepared as follows. First, a deposition solution containing cellulose nanofibers, binder resin fine particles, and an aqueous hole-opening agent can be prepared. Then, a flat surface can be coated with the deposition solution, and dried at a temperature lower than a softening point of the binder resin to form a nonwoven fabric. The nonwoven fabric can be then heated at a temperature higher than a softening point of the binder resin so that the cellulose nanofibers can be bonded with each other and coated by the binder resin at the same time. Afterwards, the nonwoven fabric can be washed to remove the aqueous hole-opening agent by using a solvent, and then, dried at a temperature lower than a softening point of the binder resin, thereby obtaining a separator.

In an example embodiment, the cellulose nanofibers and the aqueous hole-opening agent used in the preparation of the deposition solution can be the same as those described above.

The binder resin is not particularly limited so long as a material used as the binder resin masks the hydroxyl group of the cellulose nanofibers through coating and generating bonding between the cellulose nanofibers, and examples thereof include a styrene-based resin, an acryl-based resin, an organic acid vinylester-based resin, a vinylester-based resin, polyolefin, polycarbonate, polyester, polyamide, thermoplastic polyurethane, polysulfone resin, polyphenylene ether resin, polyphenylene sulfide resin, silicon resin, a rubber or an elastomer, and a polyvinylidene fluoride (PVDF) resin. In particular, in consideration of ease of the coating of the cellulose nanofibers, a PVDF resin having water dispersibility, such as a particulate PVDF resin synthesized by emulsion polymerization, can be used.

The softening point of the binder resin can be higher than a drying temperature in the preparation of the nonwoven fabric lower than a temperature at which the cellulose nanofibers are degraded. The softening point of the binder may vary depending on a process, but can be in a range of about 80° C. to about 170° C. The softening point of the binder resin can be defined by a peak temperature of the binder resin when measured by a differential scanning calorimetry (DSC) meter.

An average diameter of the particles of the binder resin is not particularly limited. However, to uniformly disperse the particles in the cellulose fibers and not to black pores in the nonwoven fabric, the average diameter of the particles of the binder resin can be about 0.01 μm or more, about 0.05 μm or more, or about 0.1 μm or more. In addition, the average diameter of the particles of the binder resin can be aboutl pm or less, about 0.5 μm or less, or about 0.3 μm or less.

An amount of the binder resin is not particularly limited so long as the amount is sufficient enough for the binder resin to coat at least a part of the cellulose nanofibers, and for example, can be, with respect to 100 parts by weight of the cellulose nanofibers, about 1 part by weight or more, about 10 parts by weight or more, or about 25 parts by weight or more. In addition, in consideration of the improvement of the strength and withstand voltage, a large amount of the binder resin can be used. However, not to block pores in the nonwoven fabric, the amount of the binder resin can be about 80 parts by weight or less or about 60 parts by weight or less.

An amount of the aqueous hole-opening agent to be added to the deposition solution may vary according to properties of a desired film. However, to secure hole openings necessary in the separator, the amount of the aqueous hole-opening agent can be, based on 100 parts by weight of the cellulose nanofibers, about 5 parts by weight or greater, about 50 parts by weight or greater, about 100 parts by weight or greater. In an example embodiment, the amount of the aqueous hole-opening agent can be, based on 100 parts by weight of the cellulose nanofibers, about 3,000 parts by weight or less, about 1,000 parts by weight or less, about 500 parts by weight or less, or about 300 parts by weight or less.

In addition, a volumetric proportion of the aqueous hole-opening agent in the deposition solution can be greater than that of the fine particles of the binder resin. For example, the volumetric proportion of the aqueous hole-opening agent in the deposition solution can be at least 3 times greater than that of the fine particles of the binder resin, or about 10 times greater than that of the fine particles of the binder resin. When the volumetric proportion of the aqueous hole-opening agent is greater than that of the fine particles, pores formed by the aqueous hole-opening agent may remain after the fine particles of the binder resin are dissolved during the post-heat treatment process.

The solvent used in the preparation of the deposition solution can be water in consideration of ease of handling and cost. However, a solvent having a higher vapor pressure than that of water can be also used.

To facilitate the coating of the cellulose nanofibers using the binder resin during the post-heat treatment process, the cellulose nanofibers and the fine particles of the binder resin can be dispersed as uniformly as possible in the deposition solution. Therefore, when preparing the deposition solution, the cellulose nanofibers, the fine particles of the binder resin, and the aqueous hole-opening agent can be mixed by using a high-pressure homogenizer. Such a high-pressure homogenizer can be used to uniformly disperse each component. In addition, instead of the high-pressure homogenizer, an ultrasonic dispersing machine, a biaxial kneading machine, or a bead mill can be used.

When preparing the deposition solution, a dispersion solution of the cellulose nanofibers and a dispersion solution of the binder resin can be prepared separately, and then, can be mixed together to prepare the deposition solution. In this regard, the cellulose nanofibers and the binder resin can be further uniformly dispersed.

In an example embodiment, the nonwoven fabric, i.e., a porous film, can be prepared by a casting method in which a flat surface is coated with the deposition solution and a heating process is performed thereon to remove a solvent by evaporation. Here, the coating using the deposition solution can be performed according to a known method in the art. For example, a flat surface can be coated with the deposition solution by using a slot die coater, a cotton coater, an MB coater, an MB-reverse coater, or an MB comma coater.

In an example embodiment, a temperature at which the heating is performed to remove the solvent (hereinafter, referred to as a heating temperature) can be lower than the softening point of the binder resin. For example, when the softening point of the binder resin is about 140° C., the heating temperature can be in a range of about 50° C. to about 100° C. To perform the heating, a hot plate, infrared irradiation, or hot air can be used. In addition, the heating can be performed in a reduced pressure environment.

After the deposition of the nonwoven fabric, the resultant can be washed with an organic solvent. The organic solvent used herein is not particularly limited, but an organic solvent having a relatively fast volatilization speed, such as toluene, acetone, methyl ethyl ketone, ethyl acetate, n-hexane, and propanol, can be used alone or in a mixture thereof. Here, the organic solvent can be used once or several times. For use of washing the residual hole-opening agent, a solvent having high affinity for water, such as ethanol or methanol, can be used. However, due to conversion of moisture of the deposition solution into a solvent or absorption of moisture in the air, a property and a shape of the nonwoven fabric can be affected. In this regard, a condition in which the water amount is controlled can be preferable. A solvent having high hydrophobicity, such as n-hexane or toluene, has a disadvantage of poor effect of washing a hydrophilic hole-opening agent. However, such a solvent can be appropriately used to make it difficult to absorb moisture. In this regard, the washing can be repeated while changing types of the solvent to gradually increase hydrophobicity thereof. For example, the washing can be performed by using acetone, toluene, and n-hexane in this stated order. After the washing of the nonwoven fabric, the organic solvent can be heated at a temperature lower than the softening point of the binder resin, thereby removing the organic solvent. For example, when the softening point of the binder resin is about 140° C., the organic solvent can be heated at a temperature in a range of about 80° C. to about 120° C. to be removed.

The heat treatment performed in terms of coating and bonding of the cellulose nanofibers can be performed at a temperature higher than the softening point of the binder resin. For example, when the softening point of the binder resin is about 140° C., the heat treatment can be performed at a temperature in a range of about 150° C. to about 170° C. By performing the heat treatment at a temperature higher than the softening point of the binder resin, the fine particles of the binder resin that are uniformly dispersed in the nonwoven fabric can be dissolved, and then, used to coat the cellulose nanofibers at the same time, thereby generating bonding between the cellulose nanofibers. To perform the heat treatment, a heater, infrared irradiation, or hot air can be used. In addition, the heat treatment can be performed in a reduced pressure environment. Here, the time required for the heat treatment can be controlled in consideration of sufficient dispersion of the fine particles of the binder resin, but for example, the heat treatment can be performed for about 1 minute to about 30 minutes.

The heating performed in terms of the removal of the solvent and the heat treatment performed in terms of the coating and bonding of the cellulose nanofibers can be performed separately using a different apparatus, or can be performed continuously using the same apparatus.

In an example embodiment, the nonwoven fabric can be pressed. As such, the pressed nonwoven fabric may provide surface smoothness or control porosity thereof. A pressure for the pressing the nonwoven fabric can be controlled according to a property of a desired film, but can be in a range of about 2 MPa to about 50 MPa. When the washing of the organic solvent is performed after the heat treatment that is performed in terms of the coating and bonding of the cellulose nanofibers, a hot-air pressing method can be used to simultaneously remove the organic solvent while pressing the nonwoven fabric.

Embodiments in which the aqueous hole-opening agent is removed before the heat treatment that is performed in terms of the coating and bonding of the cellulose nanofibers are described, but depending on types of the aqueous hole-opening agents and the softening point of the binder resin, the aqueous hole-opening agent can be used after the heat treatment that is performed in terms of the coating and bonding of the cellulose nanofibers.

When a ratio between the aqueous hole-opening agent and the fine particles of the binder resin is adjusted while the fine particles of the binder resin are uniformly dispersed in the cellulose nanofibers, pores formed by the aqueous hole-opening agent may remain even if the binder resin is melted by the heating of the dispersion solution at temperature higher than the softening point of the binder resin. Therefore, the separator made of the nonwoven fabric, which has the tensile strength and porosity required as the separator and is capable of improving the withstand voltage of the cellulose nanofibers in which the hydroxyl groups on the surfaces are masked, can be obtained.

In an example embodiment, the fine particles of the binder resin can be added to coat the cellulose nanofibers. When fine particles of a binder resin are added to obtain termination characteristics, the binder resin is rather present in the form of fine particles in a nonwoven fabric when embedded as a separator for a secondary battery. However, the binder resin according to an example embodiment has no need to be present in the form of fine particles in the nonwoven fabric, but is used to coat the cellulose nanofibers to be dispersed as uniformly as possible in the nonwoven fabric.

In an example embodiment, a pore diameter of the holes in the nonwoven fabric can be about 2 μm or less so that short circuits do not occur when fabricating or charging a battery. In addition, the porosity of the nonwoven fabric can be controlled according to a property of a desired separator, but in an example embodiment, the nonwoven fabric may have a porosity (i.e., volume of holes in the nonwoven fabric expressed as a percent of the fabric volume, as determined by the procedure given in the Example section below) of about 30% or more or about 40% or more. In addition, the nonwoven fabric may have Gurley permeability of about less than 700 seconds/100 mL or about 600 seconds/100 mL or less to obtain approximately the same characteristics as the porous film. In addition, the pore diameter of the holes in the nonwoven fabric can be measured by a mercury indentation method or a bubble point method. The pore diameter of the holes in the nonwoven fabric can be also calculated based on a specific gravity and density of the porous cellulose nanofibers. The Gurley permeability of the nonwoven fabric can be obtained by measurement according to JISP8117.

In an example embodiment, the thickness of the nonwoven fabric can be controlled according to a property of a desired separator. However, in order to increase insulation and ease of fabrication, the thickness of the nonwoven fabric can be about 10 pm or greater or about 14 μm or greater. In addition, in consideration of ionic conduction between a positive electrode and a negative electrode, the thickness of the nonwoven fabric can be about 25 μm or less or about 20 μm or less.

In an embodiment, the nonwoven fabric may have a tensile strength of about 500 kgf/cm² or greater or about 600 kgf/cm² or greater, in consideration of a strength required for the separator. The nonwoven fabric having a high tensile strength can be preferable, but in consideration of a winding property, slit property, and porosity, the nonwoven fabric may have a tensile strength of about 1,200 kgf/cm² or less. In addition, the tensile strength can be measured according to the tensile test.

In an example embodiment, in consideration of the separator performance, the nonwoven fabric having a small amount of impurities can be preferred. For example, an amount of sodium in the separator can be less than about 1 ppm. For example, an amount of moisture in the nonwoven fabric can be less than about 1,000 ppm or less than about 300 ppm. For example, an amount of the aqueous hole-opening agent remaining in the nonwoven fabric can be about 500 ppm or less. In addition, the nonwoven fabric may include, other than boron, a halogen in a minimum amount. Components included in the electrolytic solution can be also included in the nonwoven fabric in an irrelevant manner. In addition, in terms of elimination of static electricity or the like, quaternary ammonium salt, phosphonium salt, or a pyrrolidinium salt of a fluorine-containing organic acid, such as bis(trifluoromethane sulfonium)amine, can be added to the cross-linking agent solution, thereby being included in the nonwoven fabric.

As the hydroxyl group-masking component, a cross-linking agent that binds to the hydroxyl group of the cellulose nanofiber for cross-linking the cellulose nanofibers and a binder resin for coating a surface of the cellulose nanofiber can be used. The cross-linking agent can be an aluminum-containing compound or a boron-containing compound as described above. In an example embodiment, the cross-linking agent can be a silane cross-linking agent including a functional group for masking a hydroxyl group. In the case when the cross-linking agent is a silane cross-linking agent, a nonwoven fabric is prepared first as described above by using a deposition solution including cellulose nanofibers, fine particles of a binder resin, and an aqueous hole-opening agent. Afterwards, the prepared nonwoven fabric can be then dipped in a cross-linking agent solution, followed by being heated and dried to allow a cross-linking reaction at the same time. The cross-linking agent solution can be prepared in the same manner as described above. Then, if necessary, the aqueous hole-opening agent can be removed from the nonwoven fabric undergone the cross-linking reaction, and then, heat treatment can be performed thereon in terms of coating and condensation, thereby preparing a cross-linked nonwoven fabric in which the binder resin is used to allow binding between the cellulose nanofibers including coated surfaces and the cross-linking agent is used to allow masking of the hydroxyl group and cross-linking of the cellulose nanofibers.

In an embodiment, following the cross-linking of the cellulose nanofibers using the cross-linking agent, heat treatment can be performed thereby melting the binder resin. Following the heat treatment to melt the binder resin, cross-linking of the cellulose nanofibers using the cross-linking agent can be performed. In addition, heat treatment can cross-link the cellulose nanofibers and melt the binder resin at the same time,

Hereinafter, the separator according to one or more example embodiments will be described in more detail with reference to Examples and Comparative Examples. The Examples are not intended to limit the scope of the inventive concept in any way.

### EXAMPLES

<Cellulose Nanofibers >

The cellulose nanofibers are derived from pulp and have an average fiber diameter of about 100 nm, and the amount of fibers having an average fiber diameter of about 1 μm was at least 5%. Alternatively, the cellulose nanofibers are derived from pulp and have an average fiber diameter of about 50 nm, and the amount of fibers having an average fiber diameter of about 1 μm was at least 5%.

<Tensile Strength>

A specimen having a width of 15 mm and a length of 50 mm was prepared, and then, a tensile strength thereof was measured by using a tensile testing machine (a digital material testing machine manufactured by Instron). The measurement was performed 10 times, and an average value of the measurements was calculated.

<Porosity>

The porosity was calculated as the difference between the specific gravity of the nonwoven fabric and the density of the nonwoven fabric divided by the specific gravity, and the resulting value was multiplied by 100. The density of the nonwoven fabric was equal to a specific gravity of the nonwoven fabric, the density of the nonwoven fabric was calculated based on the basis weight and thickness of the nonwoven fabric, as measured using a micrometer.

<Gurley Permeability>

A Gurley permeability measuring machine, calibrated according to JISP8117 (a Gurley type densimeter manufactured by Dongyang Precision Machine), was used to measure the time for air (100 mL) to pass through a specimen closely attached to a circular hole having an outer diameter of 28.6 mm.

<Capacity Retention Rate>

The prepared nonwoven fabric was used as a separator and the separator was used to prepare a battery. Lithium cobalt oxide was used as a positive electrode and artificial graphite was used as a negative electrode of the battery. Then, the battery was charged and discharged during a 10 hour rate (at a constant voltage of 2.75 V) at a temperature of 25° C. Afterwards, the battery was changed two times with a constant voltage for a 5 hour rate, and then was discharged until a voltage thereof reached 2.75 V. The initial capacity was measured. In addition, the battery was charged three times with a constant voltage for 5 hour rate, and in the same charging condition, the battery was stored in an incubator at a temperature of 60° C. for 15 days. Then, 15 days later, the battery was taken out of the incubator, was cooled to a temperature of 25° C., and then, discharged for 5 hour rate until a voltage thereof reached 2.75 V. The discharge capacity was then measured. The ratio of the obtained discharge capacity to the initial capacity was identified as a capacity retention rate.

<Discharge Capacity>

A battery was prepared in the same manner as in the measurement of the capacity retention rate. The battery was then charged and discharged during a 10 hour rate (at a constant voltage of −2.75 V) at temperature of 25° C. (formation process).

Afterwards, the battery was charged two times for a 2 hour rate, and then, discharged for a 5 hour rate, to thereby measure the initial discharge capacity. Afterwards, the battery was charged for a 2 hour rate, and then, discharged several times, each for a 2 hour rate, a 1.25 hour rate, a 1 hour rate, a 0.5 hour rate, and a 0.2 hour rate, to thereby confirm the discharge capacity. In addition, the charging and discharging for a 1 hour rate was repeated 300 times, and then, the battery was charged for a 2 hour rate, and then, discharged for a 5 hour rate, to thereby confirm the discharge capacity. In addition, the initial capacity of a battery prepared using a dried polyolefin nonwoven fabric (manufactured by Celgard #2320 Asahi Co.) was determined to 100, to thereby accordingly standardize discharge capacity of each battery.

<Softening Point>

The softening point of the binder resin was measured by using a differential scanning calorimetry meter (EXSTAR6000 manufactured by SEIKO INSTRUMENTS Co.). Here, in a condition where a temperature was raised up to a range of about 30° C. to about 250° C., the maximum temperature of the endothermic peak was determined as the softening point.

<Average Pore Size (Diameter)>

The average pore size was measured according to the mercury porosimetry (AutoPore IV9510 type manufactured by Micromellitics Co.).

<Evaluation of Coating Condition>

An electron microscope (Tecnai G2 F20 manufactured by FEI Co.) was used to observe the surface of the nonwoven fabric. An energy dispersive X-ray spectrometer (EDX manufactured by EDAX Co.) was used to perform fluorine mapping to thereby confirm the coating condition of the cellulose nanofibers.

<Measurement of Infrared Absorption Spectrum>

Regarding the obtained sample, an ATR spectrum measurement was performed by using a Nicolet iS10 spectrometer manufactured by the Thermo Scientific, which was equipped with a diamond prism.

### Example 1

Carboxylmethyl cellulose (manufactured by San Rose MAC5OOLC, Japanese Paper Manufacturing Co., Ltd.) and triethylene glycol butyl methyl ether (manufactured by Dongbang Chemical Co., Ltd.) were added as a binder resin and an aqueous hole-opening agent, respectively, to a water suspension containing 2 weight % of cellulose nanofibers (average fiber diameter=100 nm), and then, the mixed solution was stirred, to thereby prepare a casting solution. An amount of carboxylmethyl cellulose in the binder resin was about 1 part by weight based on 100 parts by weight of the cellulose nanofibers and an amount of the aqueous hole-opening agent was about 250 parts by weight based on 100 parts by weight of the cellulose nanofibers. After the casting solution was cast on a Petri dish, the Petri dish was placed on a hot plate heated to a temperature of 85° C. The solvent and triethylene glycol butyl methyl ether were evaporated from the Petri dish on the hot plate, to thereby form a nonwoven fabric. The obtained nonwoven fabric was washed with toluene, and then, dried on the hot plate heated to a temperature of 85° C.

Next, the nonwoven fabric was dipped in a solution containing a cross-linking agent in a Petri dish. The solution containing the cross-linking agent used herein was an aqueous solution prepared by using about 0.03 parts by weight of aluminum sulfate (Al₂(SO₄)₃) (manufactured by Wako Pure Chemical Industries, Ltd.) and about 250 parts by weight of triethylene glycol butyl methyl ether 250, based on 100 parts by weight of the cellulose nanofibers of the nonwoven fabric, as a cross-linking agent and a hole-opening agent, respectively. The Petri dish was placed on the hot plate heated to a temperature of 85° C. The solvent and triethylene glycol butyl methyl ether were evaporated from the Petri dish on the hot plate, to thereby allow cross-linking of the nonwoven fabric by the cross-linking agent.. Following the cross-linking of the nonwoven fabric, the resulting nonwoven fabric was washed with toluene, and then, pressed with a pressure of about 20 MPa, thereby obtaining a cross-linked nonwoven fabric.

The thickness of the cross-linked nonwoven fabric was about 18 μm, the Gurley permeability of the cross-linked nonwoven fabric was about 205.2 seconds/100 mL, and the tensile strength of the cross-linked nonwoven fabric was about 278 kgf/cm². Regarding a battery including the obtained cross-linked nonwoven fabric as a separator, the capacity retention rate of the battery measured at a constant voltage of about 4.4 V was about 76%.

### Example 2

A cross-linked nonwoven fabric was prepared in the same manner as in Example 1, except that about 0.13 parts by weight of Al₂(SO₄)₃ was used as a cross-linking agent in preparing the solution containing the cross-linking agent.

The thickness of the cross-linked nonwoven fabric was about 18 μm, the Gurley permeability of the cross-linked nonwoven fabric was about 205.2 seconds/100 mL, and the tensile strength of the cross-linked nonwoven fabric was about 304 kgf/cm². With regard to a battery including the obtained cross-linked nonwoven fabric as a separator, the capacity retention rate of the battery measured at a constant voltage of about 4.4 V was about 76%.

### Example 3

A cross-linked nonwoven fabric was prepared in the same manner as in Example 1, except that about 0.21 parts by weight of Al₂(SO₄)₃ was used as a cross-linking agent in preparing the solution containing the cross-linking agent.

The thickness of the cross-linked nonwoven fabric was about 15 μm, the Gurley permeability of the cross-linked nonwoven fabric was about 232.4 seconds/100 mL, and the tensile strength of the cross-linked nonwoven fabric was about 368 kgf/cm². With regard to a battery using the obtained cross-linked nonwoven fabric as a separator, the capacity retention rate of the battery measured at a constant voltage of about 4.4 V was about 71%.

### Example 4

The thickness of the cross-linked nonwoven fabric was about 20 μm, the Gurley permeability of the cross-linked nonwoven fabric was about 244.8 seconds/100 mL, and the tensile strength of the cross-linked nonwoven fabric was about 323 kgf/cm². With regard to a battery using the obtained cross-linked nonwoven fabric as a separator, the capacity retention rate of the battery measured at a constant voltage of about 4.4 V was about 74%.

### Example 5

A cross-linked nonwoven fabric was prepared in the same manner as in Example 1, except that the solution containing the cross-linking agent was changed to a solution prepared by using about 0.02 parts by weight of sodium aluminate (NaAlO₂) (manufactured by Wako Pure Chemical Industries, Ltd.) and 440 parts by weight of triethylene glycol butylmethylether, based on 100 parts by weight of the cellulose nanofibers of the nonwoven fabric, as a cross-linking agent and a hole-opening agent, respectively.

The thickness of the cross-linked nonwoven fabric was about 20 μm, the Gurley permeability of the cross-linked nonwoven fabric was about 213.2 seconds/100 mL, and the tensile strength of the cross-linked nonwoven fabric was about 388 kgf/cm². With regard to a battery including the obtained cross-linked nonwoven fabric as a separator, the capacity retention rate of the battery measured at a constant voltage of about 4.4 V was about 76%.

### Example 6

A cross-linked nonwoven fabric was prepared in the same manner as in Example 5, except that about 0.10 parts by weight of NaAlO₂ was used as a cross-linking agent in preparing the solution containing the cross-linking agent.

The thickness of the cross-linked nonwoven fabric was about 14 μm, the Gurley permeability of the cross-linked nonwoven fabric was about 206.4 seconds/100 mL, and the tensile strength of the cross-linked nonwoven fabric was about 394 kgf/cm². With regard to a battery including the obtained cross-linked nonwoven fabric as a separator, the capacity retention rate of the battery measured at a constant voltage of about 4.4 V was about 76%.

### Example 7

A cross-linked nonwoven fabric was prepared in the same manner as in Example 5, except that about 0.19 parts by weight of Al₂(SO₄)₃ was used as a cross-linking agent in preparing the solution containing the cross-linking agent.

The thickness of the cross-linked nonwoven fabric was about 14 μm, the Gurley permeability of the cross-linked nonwoven fabric was about 222.4 seconds/100 mL, and the tensile strength of the cross-linked nonwoven fabric was about 394 kgf/cm². With regard to a battery including the obtained cross-linked nonwoven fabric as a separator, the capacity retention rate of the battery measured at a constant voltage of about 4.4 V was about 82%.

The conditions for cross-linking of the nonwoven fabrics and the measurement results obtained for the cross-linked nonwoven fabrics prepared according to Examples 1 to 7 are summarized in Table 1. In all corresponding Examples, the cross-linked nonwoven fabrics each showed a high tensile strength of about 250 kgf/cm² or more, and the capacity retention rate of the battery including respectively the cross-linked nonwoven fabrics as a separator was at least 70% when measured at a constant voltage of about 4.4 V.

TABLE 1

| | | Example 1 | Example 2 | Example 3 | Example 4 | Example 5 | Example 6 | Example 7 |
|---|---|---|---|---|---|---|---|---|
| Cross-linking | Types | Al₂(SO₄)₃ | Al₂(SO₄)₃ | Al₂(SO₄)₃ | Al₂(SO₄)₃ | NaAlO₂ | NaAlO₂ | NaAlO₂ |
| agent | Parts by weight | 0.03 | 0.13 | 0.21 | 0.21 | 0.02 | 0.10 | 0.19 |
| | Hole-opening agent | 250 | 250 | 250 | 440 | 440 | 440 | 440 |
| | (parts by weight) | | | | | | | |
| | Solvent | Water | Water | Water | Water | Water | Water | Water |

| | | | | | | | |
|---|---|---|---|---|---|---|---|
| Thickness (μm) | 18 | 18 | 15 | 20 | 20 | 14 | 14 |
| Gurley permeability (seconds/100 mL) | 205.2 | 205.2 | 232.4 | 244.8 | 213.2 | 206.4 | 222.4 |
| Tensile strength (kgf/cm²) | 278 | 304 | 368 | 323 | 388 | 394 | 394 |
| Capacity retention rate (%) | 76 | 76 | 71 | 74 | 76 | 76 | 82 |

### Example 8

A cross-linked nonwoven fabric was prepared in the same manner as in Example 1, except that the solution containing the cross-linking agent was changed to a 2-propanol/toluene solution prepared by using about 0.02 parts by weight of aluminum isopropoxide (manufactured by Tokyo Chemical Company, Ltd.) and 200 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 20 μm, the Gurley permeability of the cross-linked nonwoven fabric was about 214.0 seconds/100 mL, and the tensile strength of the cross-linked nonwoven fabric was about 360 kgf/cm². In a battery using the obtained cross-linked nonwoven fabric as a separator, the capacity retention rate of the battery measured at a constant voltage of about 4.4 V was about 76%.

### Example 9

A cross-linked nonwoven fabric was prepared in the same manner as in Example 8, except that a 2-propanol/toluene solution prepared by using about 0.18 parts by weight of aluminum isopropoxide and 340 parts by weight of triethylene glycol butyl methyl ether, based on100 parts by weight of the cellulose nanofibers of the nonwoven fabric, as a cross-linking agent and a hole-opening agent, respectively.

The thickness of the cross-linked nonwoven fabric was about 14 μm, the Gurley permeability of the cross-linked nonwoven fabric was about 218.3 seconds/100 mL, and the tensile strength of the cross-linked nonwoven fabric was about 321 kgf/cm². With regard to a battery including the obtained cross-linked nonwoven fabric as a separator, the capacity retention rate of the battery measured at a constant voltage of about 4.4 V was about 77%.

### Example 10

A cross-linked nonwoven fabric was prepared in the same manner as in Example 1, except that the solution containing the cross-linking agent was changed to a solution prepared by using about 0.10 parts by weight of Al(C₅H₇O₂)(C₆H₉O₃) (manufactured by Tokyo Chemical Company, Ltd.) and 200 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 19 μm, the Gurley permeability of the cross-linked nonwoven fabric was about 213.6 seconds/100 mL, and the tensile strength of the cross-linked nonwoven fabric was about 359 kgf/cm². With regard to a battery including the obtained cross-linked nonwoven fabric as a separator, the capacity retention rate of the battery measured at a constant voltage of about 4.4 V was about 78%.

The conditions for cross-linking of the nonwoven fabrics and the measurement results obtained for the cross-linked nonwoven fabrics prepared according to Examples 8 to 10 are summarized in Table 2. In all corresponding Examples, the cross-linked nonwoven fabrics each showed a high tensile strength of about 250 kgf/cm² or greater, and the capacity retention rate of the battery respectively including as a separator the cross-linked nonwoven fabrics was at least 70% when measured at a constant voltage of about 4.4 V.

TABLE 2

| | | Example 8 | Example 9 | Example 10 |
|---|---|---|---|---|
| Cross-linking | Types | Aluminum | Aluminum | Al(C₅H₇O₂)(C₆H₉O₃) |
| agent | | isopropoxide | isopropoxide | |
| | Parts by weight | 0.02 | 0.18 | 0.10 |
| | Hole-opening agent | 200 | 340 | 200 |
| | (parts by weight) | | | |
| | Solvent | 2-propanol/ | 2-propanol/ | Isopropanol |
| | | toluene | toluene | |

| | | | |
|---|---|---|---|
| Thickness (μm) | 20 | 14 | 19 |
| Gurley permeability (seconds/100 mL) | 214 | 218.3 | 213.6 |
| Tensile strength (kgf/cm²) | 360 | 321 | 359 |
| Capacity retention rate (%) | 76 | 77 | 78 |

### Example 11

A cross-linked nonwoven fabric was prepared in the same manner as in Example 1, except that the solution containing the cross-linking agent was changed to an aqueous solution prepared by using about 0.01 parts by weight of boric acid (B(OH)₃) (manufactured by Wako Pure Chemical Industries, Ltd.) and 350 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 16 μm, the Gurley permeability of the cross-linked nonwoven fabric was about 208.8 seconds/100 mL, and the tensile strength of the cross-linked nonwoven fabric was about 344 kgf/cm². With regard to a battery including the obtained cross-linked nonwoven fabric as a separator, the capacity retention rate of the battery measured at a constant voltage of about 4.4 V was about 77%.

### Example 12

A cross-linked nonwoven fabric was prepared in the same manner as in Example 11, except that about 0.14 parts by weight of B(OH)₃ was used as a cross-linking agent in preparing the solution containing the cross-linking agent.

The thickness of the cross-linked nonwoven fabric was about 14 μm, the Gurley permeability of the cross-linked nonwoven fabric was about 221.6 seconds/100 mL, and the tensile strength of the cross-linked nonwoven fabric was about 353 kgf/cm². With regard to a battery including the obtained cross-linked nonwoven fabric as a separator, the capacity retention rate of the battery measured at a constant voltage of about 4.4 V was about 74%.

### Example 13

A cross-linked nonwoven fabric was prepared in the same manner as in Example 1, except that the solution containing the cross-linking agent was changed to an ethanol solution prepared by using about 0.04 parts by weight of (HO)₂B—B(OH)₂ (manufactured by Tokyo Chemical Company, Ltd.) and 470 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 16 μm, the Gurley permeability of the cross-linked nonwoven fabric was about 210.0 seconds/100 mL, and the tensile strength of the cross-linked nonwoven fabric was about 355 kgf/cm². With regard to a battery including the obtained cross-linked nonwoven fabric as a separator, the capacity retention rate of the battery measured at a constant voltage of about 4.4 V was about 77%.

### Example 14

A cross-linked nonwoven fabric was prepared in the same manner as in Example 13, except that about 0.10 parts by weight of (HO)₂B—B(OH)₂ was used as a cross-linking agent in preparing the solution containing the cross-linking agent.

The thickness of the cross-linked nonwoven fabric was about 15 μm, the Gurley permeability of the cross-linked nonwoven fabric was about 221.6 seconds/100 mL, and the tensile strength of the cross-linked nonwoven fabric was about 368 kgf/cm². With regard to a battery using the obtained cross-linked nonwoven fabric as a separator, the capacity retention rate of the battery measured at a constant voltage of about 4.4 V was about 72%.

### Example 15

A cross-linked nonwoven fabric was prepared in the same manner as in Example 1, except that the solution containing the cross-linking agent was changed to a water/ethanol solution prepared by using a mixture of about 0.18 parts by weight of (HO)₂B—B(OH)₂ (manufactured by Tokyo Chemical Company, Ltd.) and about 0.02 parts by weight of B(OH)₃ and about 500 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 14 μm, the Gurley permeability of the cross-linked nonwoven fabric was about 201.6 seconds/100 mL, and the tensile strength of the cross-linked nonwoven fabric was about 370 kgf/cm². With regard to a battery using the obtained cross-linked nonwoven fabric as a separator, the capacity retention rate of the battery measured at a constant voltage of about 4.4 V was about 77%.

The conditions for cross-linking of the nonwoven fabrics and the measurement results obtained for the cross-linked nonwoven fabrics prepared according to Examples 11 to 15 are summarized in Table 3. In all corresponding Examples, the cross-linked nonwoven fabrics each showed a high tensile strength of about 250 kgf/cm² or greater, and the capacity retention rate of the batteries respectively including the cross-linked nonwoven fabrics as a separator was at least 70% when measured at a constant voltage of about 4.4 V.

TABLE 3

| | | Example 11 | Example 12 | Example 13 | Example 14 | Example 15 |
|---|---|---|---|---|---|---|
| Cross-linking | Types | B(OH)₃ | B(OH)₃ | (HO)₂B—B(OH)₂ | (HO)₂B—B(OH)₂ | (HO)₂B—B(OH)₂/ |
| agent | | | | | | B(OH)₃ |
| | Parts by weight | 0.01 | 0.14 | 0.04 | 0.10 | 0.18/0.02 |
| | Hole-opening agent | 350 | 350 | 470 | 470 | 500 |
| | (parts by weight) | | | | | |
| | Solvent | Water | Water | Ethanol | Ethanol | Water/ethanol |

| | | | | | |
|---|---|---|---|---|---|
| Thickness (μm) | 16 | 14 | 16 | 15 | 14 |
| Gurley permeability (seconds/100 mL) | 208.8 | 221.6 | 210.0 | 221.6 | 201.6 |
| Tensile strength (kgf/cm²) | 344 | 353 | 355 | 368 | 370 |
| Capacity retention rate (%) | 77 | 74 | 77 | 72 | 77 |

### Example 16

A cross-linked nonwoven fabric was prepared in the same manner as in Example 1, except that the solution containing the cross-linking agent was changed to a toluene solution prepared by using about 0.13 parts by weight of boric acid isopropoxide (manufactured by Tokyo Chemical Company, Ltd.) and 300 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 20 μm, the Gurley permeability of the cross-linked nonwoven fabric was about 224.2 seconds/100 mL, and the tensile strength of the cross-linked nonwoven fabric was about 341 kgf/cm². With regard to a battery including the obtained cross-linked nonwoven fabric as a separator, the capacity retention rate of the battery measured at a constant voltage of about 4.4 V was about 73%.

### Example 17

A cross-linked nonwoven fabric was prepared in the same manner as in Example 16, except that about 0.2 parts by weight of boric acid isopropoxide was used in preparing the solution containing the cross-linking agent.

The thickness of the cross-linked nonwoven fabric was about 20 μm, the Gurley permeability of the cross-linked nonwoven fabric was about 235.7 seconds/100 mL, and the tensile strength of the cross-linked nonwoven fabric was about 441 kgf/cm². With regard to a battery including the obtained cross-linked nonwoven fabric as a separator, the capacity retention rate of the battery measured at a constant voltage of about 4.4 V was about 70%.

### Example 18

A cross-linked nonwoven fabric was prepared in the same manner as in Example 1, except that the solution containing the cross-linking agent was changed to a toluene solution prepared by using about 0.04 parts by weight of bis(neopentylglycolato)diboron (manufactured by Tokyo Chemical Company, Ltd.) and about 200 parts by weight of triethylene glycol butyl methyl ether, based on 100 parts by weight of the cellulose nanofibers of the nonwoven fabric, as a cross-linking agent and a hole-opening agent, respectively.

The thickness of the cross-linked nonwoven fabric was about 17 μm, the Gurley permeability of the cross-linked nonwoven fabric was about 217.2 seconds/100 mL, and the tensile strength of the cross-linked nonwoven fabric was about 350 kgf/cm². With regard to a battery including the obtained cross-linked nonwoven fabric as a separator, the capacity retention rate of the battery measured at a constant voltage of about 4.4 V was about 74%.

The conditions for cross-linking of the nonwoven fabrics and the measurement results obtained for the cross-linked nonwoven fabrics prepared according to Examples 16 to 18 are summarized in Table 4. In all corresponding Examples, the cross-linked nonwoven fabrics each showed a high tensile strength of about 250 kgf/cm² or greater, and the capacity retention rate of the battery respectively including the cross-linked nonwoven fabrics as a separator was at least 70% when measured at a constant voltage of about 4.4 V.

TABLE 4

| | | Example 16 | Example 17 | Example 18 |
|---|---|---|---|---|
| Cross- | Types | Boric acid | Boric acid | Bis(neopentylglycolato)diboron |
| linking | | isopropoxide | isopropoxide | |
| agent | Parts by weight | 0.13 | 0.20 | 0.04 |
| | Hole-opening | 300 | 300 | 200 |
| | agent (parts by | | | |
| | weight) | | | |
| | Solvent | Toluene | Toluene | Toluene |

| | | | |
|---|---|---|---|
| Thickness (μm) | 20 | 20 | 17 |
| Gurley permeability | 224.2 | 235.7 | 217.2 |
| (seconds/100 mL) | | | |
| Tensile strength | 341 | 411 | 350 |
| (kgf/cm²) | | | |
| Capacity retention rate | 73 | 70 | 74 |
| (%) | | | |

### Comparative Example 1

A non-crosslinked nonwoven fabric was prepared in the same manner as in Example 1, except that the resulting product did not undergo cross-linking.

The thickness of the non-crosslinked nonwoven fabric was about 22 μm, the Gurley permeability of the non-crosslinked nonwoven fabric was about 199.2 seconds/100 mL, and the tensile strength of the non-crosslinked nonwoven fabric was about 159 kgf/cm². With regard to a battery using the obtained non-crosslinked nonwoven fabric as a separator, the capacity retention rates of the battery measured at a constant voltage of about 4.4 V and about 4.2 V was about 52% and about 75%, respectively.

### Comparative Example 2

A cross-linked film was prepared in the same manner as in Example 1, except that the solution containing the cross-linking agent was changed to an aqueous solution prepared by using about 0.007 parts by weight of Al₂(SO₄)₃ based on 100 parts by weight of the cellulose nanofibers of the nonwoven fabric as a cross-linking agent.

The thickness of the cross-linked nonwoven fabric was about 15 μm, the Gurley permeability of the cross-linked nonwoven fabric was about 232.4 seconds/100 mL, and the tensile strength of the cross-linked nonwoven fabric was about 162 kgf/cm². With regard to a battery using the obtained cross-linked nonwoven fabric as a separator, the capacity retention rate of the battery measured at a constant voltage of about 4.4 V was about 54%.

### Comparative Example 3

A cross-linked film was prepared in the same manner as in Example 1, except that about 0.23 parts by weight of Al₂(SO₄)₃ was used in preparing the solution containing the cross-linking agent.

The thickness of the cross-linked nonwoven fabric was about 15 μm, the Gurley permeability of the cross-linked nonwoven fabric was about 1,634 seconds/100 mL, and the tensile strength of the cross-linked nonwoven fabric was about 304 kgf/cm². With regard to a battery including the obtained cross-linked nonwoven fabric as a separator, the capacity retention rate of the battery measured at a constant voltage of about 4.4 V was about 66%.

Data obtained for each of the products prepared according to Comparative Examples 1 to 3 are summarized in Table 5. In Comparative Example 1 where the nonwoven fabric was not cross-linked, the tensile strength of the product was less than about 200 kgf/cm². In addition, the capacity retention rate of the battery including as a separator the product of Comparative Example 1 was about 75% when measured at a constant voltage of about 4.2 V, but dropped to about 52% when measured at an increased voltage of about 4.4 V.

In addition, in Comparative Example 2 where the amount of the cross-linking agent was small, the tensile strength of the product was less than about 200 kgf/cm², and the capacity retention rate of the battery including as a separator the product of Comparative Example 2 was less than about 70%. However, in Comparative Example 3 where the amount of the cross-linking agent was greater than that of the product of Comparative Example 2, the tensile strength of the product of Comparative Example 3 was also greater than that of the product of Comparative Example 2, but the capacity retention of the battery including as a separator the product of Comparative Example 3 was also less than about 70%

TABLE 5

| | | Comparative | Comparative | Comparative |
|---|---|---|---|---|
| | | Example 1 | Example 2 | Example 3 |
| Cross- | Types | — | Al₂(SO₄)₃ | Al₂(SO₄)₃ |
| linking | Parts by weight | — | 0.007 | 0.23 |
| agent | Hole-opening | — | 250 | 250 |
| | agent (parts by | | | |
| | weight) | | | |
| | Solvent | — | Water | Water |

| | | | |
|---|---|---|---|
| Thickness (μm) | 22 | 15 | 15 |
| Gurley permeability | 199.2 | 232.4 | 1,634 |
| (seconds/100 mL) | | | |
| Tensile strength | 159 | 162 | 304 |
| (kgf/cm²) | | | |
| Capacity retention (%) | 75 (at 4.2 V)/52 | 54 | 66 |
| | (at 4.4 V) | | |

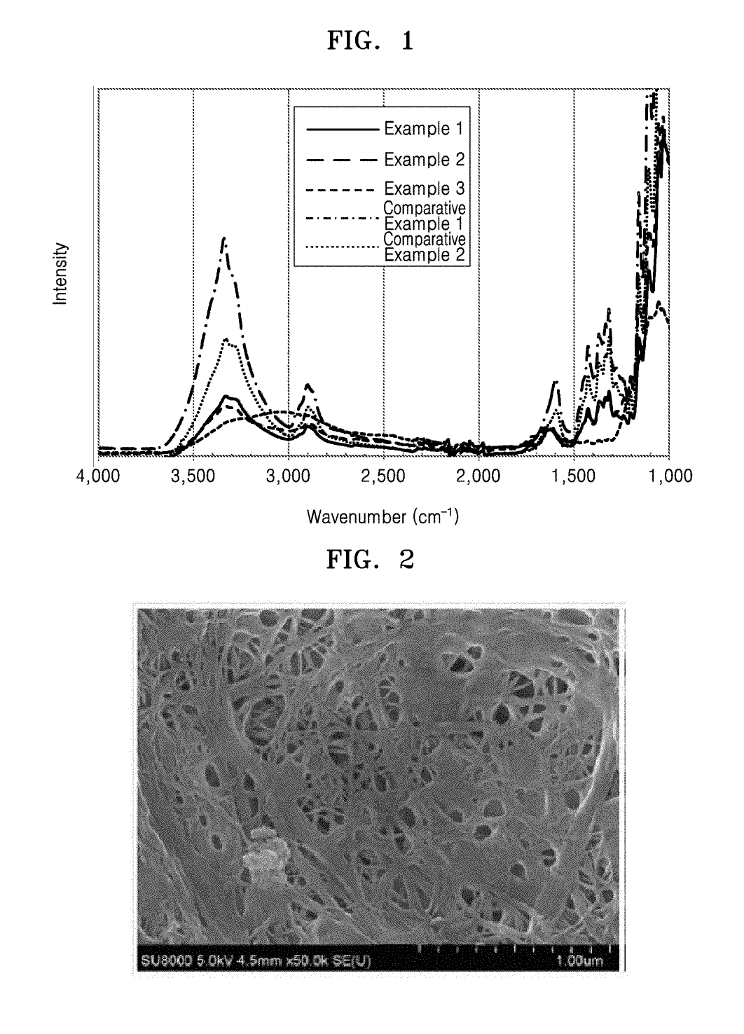

FIG. 1 is a spectrum image showing results of infrared total reflection absorption measurements (ATR) on the cross-linked nonwoven fabrics prepared according to Examples 1 to 3 and Comparative Examples 1 and 2. In FIG. 1, the absorption intensity of the vertical axis was normalized by a peak observed near 1430 cm⁻¹.

Referring to FIG. 1, in Comparative Example 1 where the nonwoven fabric was not cross-linked, peaks were observed at about 1600 cm⁻¹ of the spectrum, the peaks corresponding to conjugates in hydrogen bonds between the cellulose nanofibers. In addition, in Comparative Example 1, peaks were observed at a range from about 3300 cm⁻¹ to 3400 cm⁻¹ of the spectrum, the peaks corresponding to hydroxyl groups (OH groups). In Comparative Example 2 where the nonwoven fabric was cross-linked with a small amount of Al₂(SO₄)₃, all peaks observed at about 1,600 cm⁻¹ and in a range from about 3,300 cm⁻¹ to about 3,400 cm⁻¹ became small.

However, in Examples 1 to 3 where the nonwoven fabrics were each cross-linked with Al₂(SO₄)₃, all peaks observed at about 1,600 cm⁻¹ and in a range from about 3,300 cm⁻¹ to about 3,400 cm⁻¹ became much smaller than peaks of the product of Comparative Example 1. That is, these results indicate that hydrogen bonds between the cellulose nanofibers were made through aluminum, and most of the hydroxyl groups on the surfaces of the cellulose nanofibers were masked with aluminum.

### Example 19

0.75 parts by weight of 20 weight % water-dispersible PVDF fine particle dispersion as a binder resin and 1.25 parts by weight of triethylene glycol butyl methyl ether (manufactured by Dongbang Chemical Co., Ltd.) as an aqueous hole-opening agent, based on 100 parts by weight of a water suspension containing 0.5 weight % of cellulose nanofibers (average fiber diameter=50 nm), were mixed uniformly by using a high-pressure homogenizer (L-100 manufactured by Samwha Engineering Co., Ltd), thereby preparing a deposition solution. Here, an amount of the PVDF fine particles in the deposition solution was about 30 parts by weight based on 100 parts by weight of the cellulose nanofibers, and an amount of the aqueous hole-opening agent was about 250 parts by weight based on 100 parts by weight of the cellulose nanofibers. The PVDF fine particles included primary particles obtained by emulsion polymerization and having an average particle diameter of about 140 nm, and had a softening point of about 140° C. A volumetric proportion of the aqueous hole-opening agent in the deposition solution was about 1.3%, and a volumetric proportion of the PVDF fine particles was about 0.082%.

After the deposition solution was cast on a Petri dish, the Petri dish was placed on a hot plate heated at a temperature of 85° C. The solvent was evaporated from the Petri dish on the hot plate, to thereby form a nonwoven fabric. The obtained nonwoven fabric was washed with toluene, and then, dried on the hot plate heated at a temperature of 85° C.

Next, heat treatment was performed on the nonwoven fabric so that the PVDF fine particles were thermally melted, to thereby perform coating and condensation of the cellulose nanofibers (wherein the heat treatment was performed by performing a hot press forming process on the nonwoven fabric with a pressure of about 20 Pa at a temperature of 160° C. for about 30 seconds).

The obtained nonwoven fabric had the thickness of about 20 μm, the Gurley permeability of about 550 seconds/100 mL, the average pore diameter of about 64 nm, the porosity of about 43%, and the tensile strength of about 700 kgf/cm². Regarding a battery including the obtained nonwoven fabric as a separator, the capacity retention ratio of the battery measured at a constant voltage of about 4.4 V was about 70%.

### Example 20

A nonwoven fabric was formed and dried in the same manner as in Example 19 by using a deposition solution containing PVDF fine particles and an aqueous hole-opening agent.

Next, the nonwoven fabric was dipped in a cross-linking agent solution in a Petri dish, and the Petri dish was placed on a hot plate heated at a temperature of 85° C. The solvent and triethylene glycol butyl methyl ether were evaporated from the Petri dish while cross-linking of the nonwoven fabric occurred. The cross-linking agent solution used herein was an aqueous solution prepared by using about 0.03 parts by weight of aluminum sulfate (manufactured by Wako Pure Chemical Industries, Ltd.) and about 250 parts by weight of triethylene glycol butyl methyl ether 250, based on 100 parts by weight of the cellulose nanofibers of the nonwoven fabric. Following the cross-linking of the nonwoven fabric, the resulting nonwoven fabric was washed with toluene to remove the aqueous hole-opening agent. Afterwards, heat treatment was performed thereon so that PVDF fine particles were thermally melted to thereby perform coating and condensation of the cellulose nanofibers (wherein the heat treatment was performed by performing a hot press forming process on the nonwoven fabric with a pressure of about 20 mPa at a temperature of 160° C. for about 30 seconds).

The obtained nonwoven fabric had the thickness of about 20 μm, the Gurley permeability of about 565 seconds/100 mL, the average pore diameter of about 60 nm, the porosity of about 41%, and the tensile strength of about 1,000 kgf/cm². Regarding a battery including the obtained nonwoven fabric as a separator, the capacity retention ratio of the battery measured at a constant voltage of about 4.4 V was about 80%.

### Example 21

A nonwoven fabric was formed and dried in the same manner as in Example 19 by using a deposition solution containing PVDF fine particles and an aqueous hole-opening agent.

Next, the nonwoven fabric was dipped in a cross-linking agent solution in a Petri dish. The cross-linking agent solution used herein was prepared by adding and hydrolyzing 3-aminopropyl trimethoxy silane (manufactured by Sigma-Aldrich Co.) in a mixed solution of ethanol/water (80/20 (v/v%)) so that an amount of the resulting solution was about 1 weight % and adding 12.5 parts by weight of triethylene glycol butyl methyl ether thereto. After being dipped, the nonwoven fabric was heated at a temperature of 110° C. for 1 hour to perform coating and condensation of the cellulose nanofibers. Afterwards, the nonwoven fabric was washed with ethanol to thereby remove the unreacted silane cross-linking agent and the remaining aqueous hole-opening agent, and then, heat treatment was performed thereon so that PVDF fine particles were thermally melted to thereby perform coating and condensation of the cellulose nanofibers (wherein the heat treatment was performed by performing a hot press forming process on the nonwoven fabric with a pressure of about 20 mPa at a temperature of 160° C. for about 30 seconds).

The obtained nonwoven fabric had the thickness of about 19 μm, the Gurley permeability of about 554 seconds/100 mL, the average pore diameter of about 63 nm, the porosity of about 43%, and the tensile strength of about 1,045 kgf/cm². Regarding a battery including the obtained nonwoven fabric as a separator, the capacity retention ratio of the battery measured at a constant voltage of about 4.4 V was about 77%.

### Comparative Example 4

A nonwoven fabric was prepared in the same manner as in Example 19, except that that PVDF fine particles were not added and heat treatment was not performed.

The obtained nonwoven fabric had the thickness of about 18μm, the Gurley permeability of about 300 seconds/100 mL, the average pore diameter of about 66 nm, the porosity of about 48%, and the tensile strength of about 360 kgf/cm². Regarding a battery including the obtained nonwoven fabric as a separator, the capacity retention ratio of the battery measured at a constant voltage of about 4.4 V was about 52%.

### Comparative Example 5

A nonwoven fabric was prepared in the same manner as in Example 19, except that that heat treatment was not performed.

The obtained nonwoven fabric had the thickness of about 20 μm, the Gurley permeability of about 300 seconds/100 mL, the average pore diameter of about 66 nm, the porosity of about 48%, and the tensile strength of about 360 kgf/cm². Regarding a battery including the obtained nonwoven fabric as a separator, the capacity retention ratio of the battery measured at a constant voltage of about 4.4 V was about 55%.

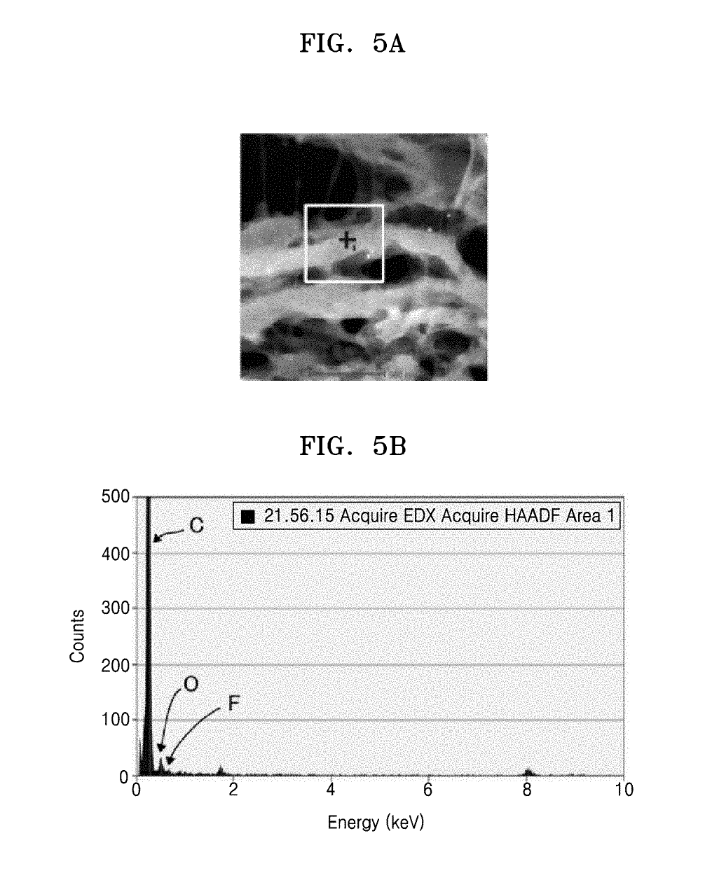

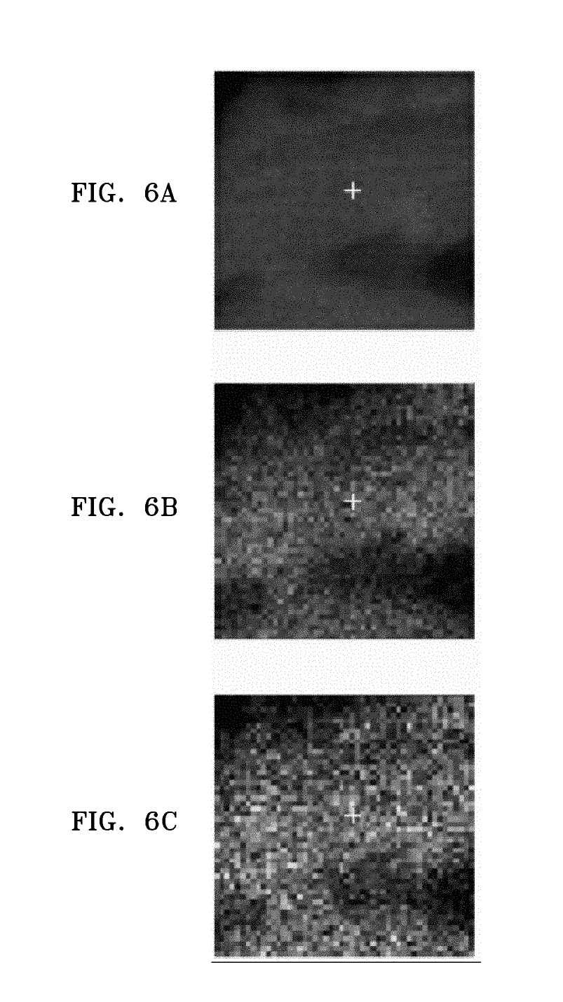

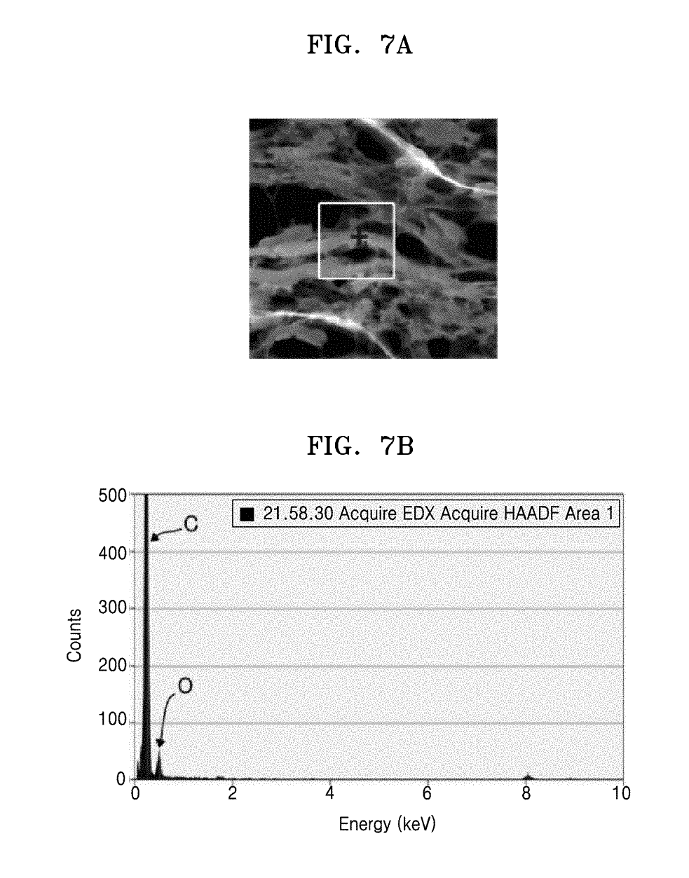

Regarding the nonwoven fabrics prepared according to Examples 19 to 21 and Comparative Examples 4 and 5, the preparation conditions and characteristics of the nonwoven fabric are summarized in Table 6. FIGS. 5A-5B show X-ray spectroscopic measurements on a cross-linked nonwoven fabric prepared according to Example 19. FIGS. 6A-6C show element mapping results on a cross-linked nonwoven fabric prepared according to Example 19. FIGS. 7A-7B show X-ray spectroscopic measurements on a cross-linked nonwoven fabric prepared according to Comparative Example 5.

TABLE 6

| | | | | | Comparative | Comparative |
|---|---|---|---|---|---|---|
| | | Example 19 | Example 20 | Example 21 | Example 4 | Example 5 |
| Fine particles (parts by weight) | | 30 | 30 | 30 | — | 30 |
| Heat treatment | Temperature (° C.) | 160 | 160 | 160 | — | — |
| | Time (seconds) | 30 | 30 | 30 | — | — |

| | | | | | |
|---|---|---|---|---|---|
| Cross-linking agent | — | Al₂(SO₄)₃ | 3-aminopopyltri- | | |
| | | | methoxysilane | | |
| Thickness (μm) | 20 | 20 | 19 | 18 | 20 |
| Gurley permeability (seconds/100 mL) | 550 | 565 | 554 | 300 | 300 |
| Average pore diameter (nm) | 64 | 60 | 63 | 66 | 66 |
| Porosity | 43 | 41 | 43 | 48 | 48 |
| Tensile strength (kgf/cm²) | 700 | 1000 | 1045 | 360 | 360 |
| Capacity retention ratio (%) | 70 | 80 | 77 | 52 | 55 |

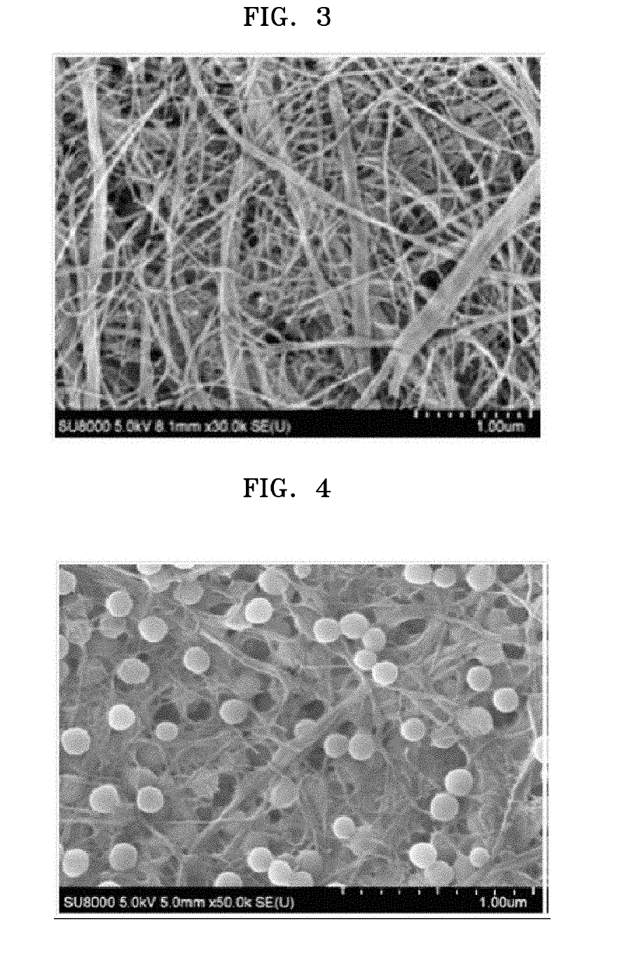

FIGS. 2 to 4 are each an electron microscopic image showing the nonwoven fabric prepared according to Example 19 and Comparative Examples 4 and 5. The nonwoven fabric prepared according to Comparative Example 5 in which the heat treatment was not performed remained the PVDF fine particles as they are, whereas the nonwoven fabric prepared according to Example 19 in which the heat treatment was performed at a temperature higher than the softening point of the PVDF fine particles showed that the PVDF fine particles were thermally melted resulting in the coating and condensation of the cellulose nanofibers at the same time. In the nonwoven fabrics prepared according to Example 19 and Comparative Examples 4 and 5, the pores remained.

### Example 22

Carboxylmethyl cellulose (manufactured by San Rose MAC500LC, Japanese Paper Manufacturing Co., Ltd.) and triethylene glycol butyl methyl ether (manufactured by Dongbang Chemical Co., Ltd.) were added as a binder resin and an aqueous hole-opening agent, respectively, to a water suspension containing 2 weight % of cellulose nanofibers, and then, the mixed solution was stirred, to thereby prepare a casting solution. An amount of the binder resin was about 1 part by weight based on 100 parts by weight of the cellulose nanofibers and an amount of the aqueous hole-opening agent was about 250 parts by weight based on 100 parts by weight of the cellulose nanofibers. After the casting solution was cast on a Petri dish, the Petri dish was placed on a hot plate heated to a temperature of 85□. The solvent and triethylene glycol butyl methyl ether were evaporated from the Petri dish on the hot plate, to thereby form a nonwoven fabric. The obtained nonwoven fabric was washed with toluene, and then, dried on the hot plate heated to a temperature of 85□.

Next, regarding the obtained nonwoven fabric, which was not cross-linked yet, a silane cross-linking agent was used to allow cross-linking of the nonwoven fabric. The silane cross-linking agent used herein was 3-aminopropyl trimethoxy silane (manufactured by Sigma-Aldrich Co.). A cross-linking agent solution was prepared in a way that the silane cross-linking agent was added to a mixed solution of ethanol/water (80/20 (v/v %)) so that an amount of the resulting solution was about 1 weight %, followed by being hydrolyzed, and then, 6.25 parts by weight of triethylene glycol butyl methyl ether was added to the obtained hydrolyzed solution

The nonwoven fabric, which was not cross-linked yet, was dipped in the prepared cross-linking agent solution so that the nonwoven fabric was impregnated with the cross-linking agent solution. Afterwards, the nonwoven fabric was heated at a temperature of 110° C. for 1 hours to perform coating and condensation of the cellulose nanofibers. Afterwards, the nonwoven fabric was washed with ethanol and dried as being placed on the hot plate heated at a temperature of, 85° C., to thereby obtain a cross-linked nonwoven fabric.

The amount of the silane cross-linking agent with respect to the cellulose nanofibers was calculated from the mass of the nonwoven fabric before and after the cross-linking thereof, and the calculated amount was 17 weight %. The obtained nonwoven fabric had the tensile strength of about 708 kgf/cm², the porosity of about 64%, and the Gurley permeability of about 444 seconds/100 mL. As compared with the uncross-linked nonwoven fabric being pressed and having the same porosity as the cross-linked nonwoven fabric, the obtained cross-linked nonwoven fabric showed the strength increase rate of about 32%.

Regarding a test battery including the obtained cross-linked nonwoven fabric as a separator, the initial discharge capacity was 99, the discharge capacity over a 0.2 hour rate was 79, and the discharge capacity over a 5 hour rate after the charge/discharge cycle test was 87.

### Example 23

A nonwoven fabric was formed and dried in the same manner as in Example 22, except that 12.5 parts by weight of triethylene glycol butyl methyl ether was added to the cross-linking agent solution .

The amount of the silane cross-linking agent with respect to the cellulose nanofibers was 20 weight %. The obtained nonwoven fabric had the tensile strength of about 531 kgf/cm², the porosity of about 71%, and the Gurley permeability of about 226 seconds/100 mL. As compared with the uncross-linked nonwoven fabric being pressed and having the same porosity as the cross-linked nonwoven fabric, the obtained cross-linked nonwoven fabric showed the strength increase rate of about 21%.

### Example 24

A nonwoven fabric was formed and dried in the same manner as in Example 23, except that the amount of the cross-linking agent was about 0.5 weight %.

The amount of the silane cross-linking agent with respect to the cellulose nanofibers was 10 weight %. The obtained nonwoven fabric had the tensile strength of about 564 kgf/cm², the porosity of about 69%, and the Gurley permeability of about 227 seconds/100 mL. As compared with the uncross-linked nonwoven fabric being pressed and having the same porosity as the cross-linked nonwoven fabric, the obtained cross-linked nonwoven fabric showed the strength increase rate of about 23%.

### Example 25

A nonwoven fabric was formed and dried in the same manner as in Example 23, except that the amount of the cross-linking agent was about 2 weight %.

The amount of the silane cross-linking agent with respect to the cellulose nanofibers was 24 weight %. The obtained nonwoven fabric had the tensile strength of about 584 kgf/cm², the porosity of about 67%, and the Gurley permeability was about 260 seconds/100 mL. As compared with the uncross-linked nonwoven fabric being pressed and having the same porosity as the cross-linked nonwoven fabric, the obtained cross-linked nonwoven fabric showed the strength increase rate of about 20%.

### Example 26

A nonwoven fabric was formed and dried in the same manner as in Example 23, except that the amount of the cross-linking agent was about 3 weight %.

The amount of the silane cross-linking agent with respect to the cellulose nanofibers was 30 weight %. The obtained nonwoven fabric had the tensile strength of about 523 kgf/cm², the porosity of about 69%, and the Gurley permeability was about 229 seconds/100 mL. As compared with the uncross-linked nonwoven fabric being pressed and having the same porosity as the cross-linked nonwoven fabric, the obtained cross-linked nonwoven fabric showed the strength increase rate of about 16%

### Example 27

A nonwoven fabric was formed and dried in the same manner as in Example 23, except that the cross-linking agent was N-(3-(trimethoxysilyl)propyl)ethylenediamine.

The amount of the silane cross-linking agent with respect to the cellulose nanofibers was 16 weight %. The obtained nonwoven fabric had the tensile strength of 527 kgf/cm², the porosity of about 71%, and the Gurley permeability of about 131 seconds/100 mL. As compared with the uncross-linked nonwoven fabric being pressed and having the same porosity as the cross-linked nonwoven fabric, the obtained cross-linked nonwoven fabric showed the strength increase rate of about 21%.

### Example 28

A nonwoven fabric was formed and dried in the same manner as in Example 23, except that the cross-linking agent was N-(3-(trimethoxysilyl)propyl)ethylenediamine, and the amount of the cross-linking agent was about 0.5 weight %.

The amount of the silane cross-linking agent with respect to the cellulose nanofibers was 6.8 weight %. The obtained nonwoven fabric had the tensile strength of 558 kgf/cm², the porosity of about 71%, and the Gurley permeability of about 124 seconds/100 mL. As compared with the uncross-linked nonwoven fabric being pressed and having the same porosity as the cross-linked nonwoven fabric, the obtained cross-linked nonwoven fabric showed the strength increase rate of about 27%.

### Comparative Example 6

A nonwoven fabric was formed and dried in the same manner as in Example 23, except that the amount of the cross-linking agent was about 5 weight %.

The amount of the silane cross-linking agent with respect to the cellulose nanofibers was 44 weight %. The obtained nonwoven fabric had the tensile strength of 444 kgf/cm², the porosity of about 70%, and the Gurley permeability was about 175 seconds/100 mL. As compared with the uncross-linked nonwoven fabric being pressed and having the same porosity as the cross-linked nonwoven fabric, the obtained cross-linked nonwoven fabric showed the strength increase rate of about 0.8%.

### Comparative Example 7

A nonwoven fabric was formed and dried in the same manner as in Example 23, except that the cross-linking agent was N-(3-(trimethoxysilyl)propyl)ethylenediamine and the amount of the cross-linking agent was about 5 weight %.

The amount of the silane cross-linking agent with respect to the cellulose nanofibers was 48 weight %. The obtained nonwoven fabric had the tensile strength of about 468 kgf/cm², the porosity of about 66%, and the Gurley permeability of about 207 seconds/100 mL. As compared with the uncross-linked nonwoven fabric being pressed and having the same porosity as the cross-linked nonwoven fabric, the obtained cross-linked nonwoven fabric showed the strength increase rate of about −6.3%.

### Comparative Example 8

A nonwoven fabric was formed and dried in the same manner as in Example 23, except that cross-linking agent was N-methyl-3-(trimethoxysiyl)propylamine and the amount of the cross-linking agent was about 1 weight %.

The amount of the silane cross-linking agent with respect to the cellulose nanofibers was about 11 weight %. The obtained nonwoven fabric had the tensile strength of 422 kgf/cm², the porosity of about 72%, and the Gurley permeability of about 146 seconds/100 mL. As compared with the uncross-linked nonwoven fabric being pressed and having the same porosity as the cross-linked nonwoven fabric, the obtained cross-linked nonwoven fabric showed the strength increase rate of about 0.5%.

### Comparative Example 9

A nonwoven fabric was formed and dried in the same manner as in Example 23, except that the cross-linking agent was trimethoxypropylsilane and the amount of the cross-linking agent was about 10 weight %.

The amount of the silane cross-linking agent with respect to the cellulose nanofibers was about 3.0 weight %. The obtained nonwoven fabric had the tensile strength of about 353 kgf/cm², the porosity of about 73%, and the Gurley permeability of about 82 seconds/100 mL. As compared with the uncross-linked nonwoven fabric being pressed and having the same porosity as the cross-linked nonwoven fabric, the obtained cross-linked nonwoven fabric showed the strength increase rate of about -13%.

### Comparative Example 10

A uncross-linked nonwoven fabric was used, and the measurements were obtained in the same manner as in Example 23, and that is, the tensile strength was about 295 kgf/cm², the porosity was about 76%, and the Gurley permeability was about 88 seconds/100 mL.

### Comparative Example 11

After the uncross-linked nonwoven fabric was pressed and compressed, the measurements were obtained in the same manner as in Example 23, and that is, the tensile strength was about 537 kgf/cm², the porosity was about 64%, and the Gurley permeability was about 216 seconds/100 mL.

Regarding a battery including the obtained uncross-linked nonwoven fabric of Comparative Example 11 as a separator, the initial discharge capacity was 96, the discharge capacity over a 0.2 hour rate was 67, and the discharge capacity over a 5 hour rate after the charge/discharge cycle test was 82.

### Comparative Example 12

Regarding a test battery using a dried polyolefin porous film (manufactured by Celgard #2320 Asahi Co.), the discharge capacity was measured in the same conditions, and consequently, the initial discharge capacity was 100, the discharge capacity over a 0.2 hour rate was 81, and the discharge capacity over a 5 hour rate after the charge/discharge cycle test was 76.

The properties of the nonwoven fabrics of Examples 22 to 28 are summarized in Table 7, and the properties of the nonwoven fabric of Comparative Examples 6 to 12 are summarized in Table 8.

TABLE 7

| | | Example 22 | Example 23 | Example 24 | Example 25 | Example 26 | Example 27 | Example 28 |
|---|---|---|---|---|---|---|---|---|
| Cross-linking | Cross-linking | 3-aminopro- | 3-aminopro- | 3-aminopro- | 3-aminopro- | 3-aminopro- | N-(3-(trime- | N-(3-(trime- |
| agent solution | agent | pyltrime- | pyltrime- | pyltrime- | pyltrime- | pyltrime- | thoxysilyl)pro- | thoxysilyl)pro- |
| | | thoxysilane | thoxysilane | thoxysilane | thoxysilane | thoxysilane | pyl)ethylene- | pyl)ethylene- |
| | | | | | | | diamine | diamine |
| | (weight %) | 1 | 1 | 0.5 | 2 | 3 | 1 | 0.5 |
| | Hole-opening agent | 6.25 | 12.5 | 12.5 | 12.5 | 12.5 | 12.5 | 12.5 |
| | (parts by weight) | | | | | | | |

| | | | | | | | |
|---|---|---|---|---|---|---|---|
| Amount of silane cross-linking agent | 17 | 20 | 10 | 24 | 30 | 16 | 6.8 |
| (weight %) | | | | | | | |
| Tensile strength (kgf/cm²) | 708 | 531 | 564 | 584 | 523 | 527 | 558 |
| Strength increase rate (%) | 32 | 21 | 23 | 20 | 16 | 21 | 27 |
| Porosity (%) | 64 | 71 | 69 | 67 | 69 | 71 | 71 |
| Gurley permeability (seconds/100 mL) | 444 | 226 | 227 | 260 | 229 | 131 | 124 |

TABLE 8

| | | Comparative | Comparative | Comparative | Comparative | Comparative | Comparative |
|---|---|---|---|---|---|---|---|
| | | Example 6 | Example 7 | Example 8 | Example 9 | Example 10 | Example 11 |
| Cross-linking | Cross-linking | 3-aminopropyl- | N-(3-(trimethoxy- | N-methyl-3-(trimethoxy- | Trimethoxy- | — | Press |
| agent solution | agent | trimethoxy- | silyl)propyl)ethylene- | silyl)propyl)amine | propylsilane | | Compression |
| | | silane | diamine | | | | |
| | (weight %) | 5 | 5 | 1 | 10 | — | |
| | Hole-opening agent | 12.5 | 12.5 | 12.5 | 12.5 | — | |
| | (part by weight) | | | | | | |

| | | | | | | |
|---|---|---|---|---|---|---|
| Amount of silane cross-linking agent | 44 | 48 | 11 | 3.0 | — | — |
| (weight %) | | | | | | |
| Tensile strength (kgf/cm²) | 444 | 468 | 422 | 353 | 295 | 537 |
| Strength increase rate (%) | 0.8 | −6.3 | 0.5 | −13 | — | — |
| Porosity (%) | 70 | 66 | 72 | 73 | 76 | 64 |
| Gurley permeability (seconds/100 mL) | 175 | 207 | 146 | 82 | 88 | 216 |

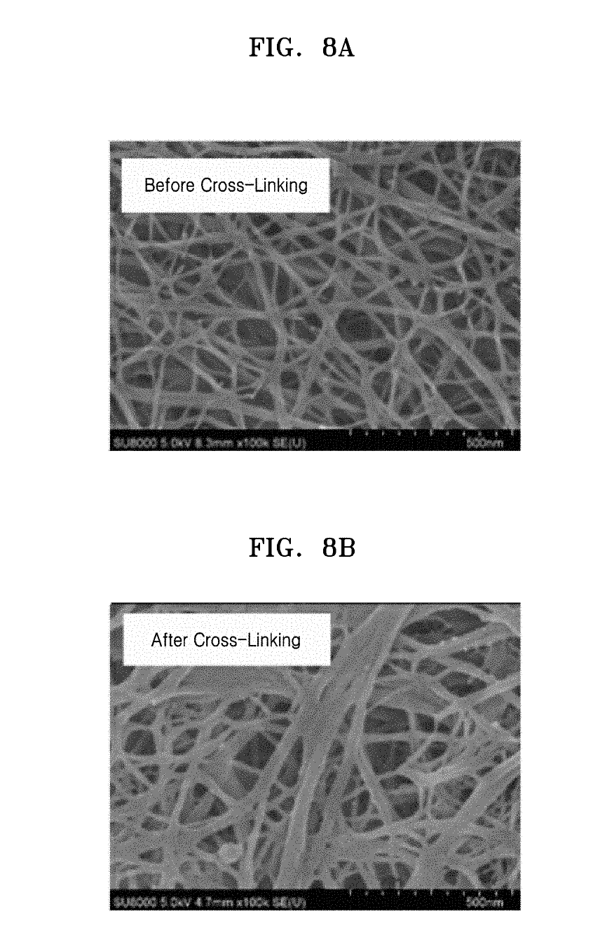

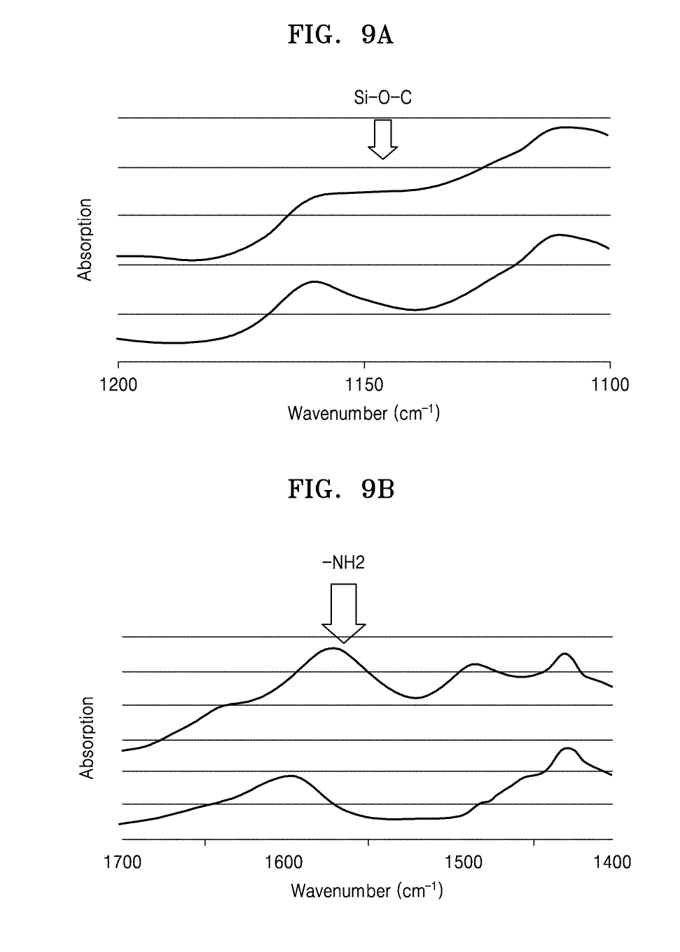

FIGS. 8A and 8B each show an electron microscopic image showing the nonwoven fabric in a state before and after performing cross-linking thereon according to Example 21. Referring to FIGS. 8A and 8B, after the cross-linking by the silane cross-linking agent, the nonwoven fabric definitely maintained its porosity. FIGS. 9A and 9B show spectrum images each showing results of infrared absorption measurements on a nonwoven fabric in a state before and after performing cross-linking thereon according to Example 21. Referring to FIGS. 9A and 9B, absorption near 1,150 cm⁻¹ where the Si—O—C bonding was newly generated as compared to the case before the cross-linking and absorption near 1,570 cm⁻¹ generated by —NH² were observed, thereby confirming the silane cross-linking agent was covalently bonded.

Table 9 shows the evaluation results of discharge capacity of the test batteries according to Example 22 and Comparative Examples 11 and 12.

TABLE 9

| | | | Comparative | Comparative |
|---|---|---|---|---|
| | | Example 22 | Example 11 | Example 12 |
| Discharge | Initial | 99 | 96 | 100 |
| capacity | 0.2 hour rate | 79 | 67 | 81 |
| | After cycle test | 87 | 82 | 76 |

According to one or more example embodiments of the present inventive concept, a separator for a nonaqueous electrolyte secondary battery has high strength and withstand voltage, and thus, a nonaqueous electrolyte secondary battery including the separator has improved characteristics.

It should be understood that the example embodiments described herein should be considered in a descriptive sense only and not for purposes of limitation. Descriptions of features or aspects within each example embodiment should typically be considered as available for other similar features or aspects in other embodiments.

While one or more example embodiments have been described with reference to the figures, it will be understood by those of ordinary skill in the art that various changes in form and details can be made therein without departing from the spirit and scope as defined by the following claims.

What is claimed is:

1. A separator for a nonaqueous electrolyte secondary battery, the separator comprising:
a plurality of cellulose nanofibers; and
a hydroxyl group-masking component for masking a hydroxyl group on a surface of the cellulose nanofibers,
wherein the cellulose nanofibers are cross-linked by the hydroxyl group-masking component to form a nonwoven fabric.

2. The separator of claim 1, wherein the hydroxyl group-masking component comprises a cross-linking agent that is linked with a hydroxyl group of the cellulose nanofibers thereby cross-linking the cellulose nanofibers,
wherein the cross-linking agent comprises at least one component selected from aluminum, boron and silane.

3. The separator of claim 2, wherein the cross-linking agent comprises at least one of an organic aluminum-containing compound and an organic boron-containing compound.

4. The separator of claim 2, wherein the cross-linking agent comprises at least one of aluminum sulfate, aluminum oxysalt, boron sulfate, and boron oxysalt.

5. The separator of claim 2, wherein an amount of the cross-linking agent is in a range of about 0.01 parts by weight to about 0.21 parts by weight per 100 parts by weight of the cellulose nanofibers.

6. The separator of claim 1, wherein the hydroxyl group-masking component comprises a binder resin that coats a surface of the cellulose nanofibers.

7. The separator of claim 6, wherein the binder resin is a water-dispersible polyvinylidene fluoride resin.

8. The separator of claim 6, wherein the separator comprises the binder resin in an amount of about 1 part by weight to about 80 parts by weight per 100 parts by weight of the cellulose nanofibers, and
porosity of the nonwoven fabric is about 30% or more.

9. The separator of claim 1, wherein the hydroxyl group-masking component comprises a silane cross-linking agent comprising a first amine group.

10. The separator of claim 9, wherein the silane cross-linking agent is represented by NH₂—R—Si—(OH)₃ in a hydrolyzed state, wherein R is a substituted or unsubstituted C₁-C₆ alkyl group.

11. The separator of claim 10, wherein R is (CH₂)ₙ(NH)ₘ (where 3≦n+m≦6).

12. The separator of claim 9, wherein an amount of the silane cross-linking agent is in a range of about 5 weight % to about 40 weight % with respect to the cellulose nanofibers, and
the porosity of the nonwoven fabric is about 40% to about 80%.

13. The separator of claim 1, wherein about 90 weight % or more of the cellulose nanofibers have an average fiber diameter of less than about 1 μm in the cellulose nanofibers.

14. A nonaqueous electrolyte secondary battery comprising the separator of claim 1.

15. A method of preparing a separator for a nonaqueous electrolyte, the method comprising:
preparing a nonwoven fabric from a deposition solution comprising a plurality of cellulose nanofibers and an aqueous hole-opening agent; and
masking a hydroxyl group on a surface of the cellulose nanofibers of the obtained nonwoven fabric.

16. The method of claim 15, wherein the masking of the hydroxyl group comprises impregnating the nonwoven fabric with a solution containing a cross-linking agent,
wherein the cross-linking agent comprises at least one component selected from aluminum, boron and silane, and
wherein the cross-linking agent binds to a hydroxyl group of the cellulose nanofibers to mask the hydroxyl group and allow cross-linking of the cellulose nanofibers.

17. The method of claim 15, wherein the deposition solution comprises particles of a binder resin having water dispersibility, and
masking of the hydroxyl group comprises heating the nonwoven fabric at a temperature higher than a softening point of the binder resin.
wherein the binder resin coats a surface of the cellulose nanofibers to mask the hydroxyl group on the cellulose nanofibers and allow cross-linking of the cellulose nanofibers.

18. The method of claim 17, wherein the particles of the binder resin have an average particle diameter of about 0.01 μm to about 1 μm.

19. The method of claim 17, wherein the method comprises, before heating the nonwoven fabric at a temperature higher than a softening point of the binder resin, removing the aqueous hole-opening agent in the nonwoven fabric.

20. The method of claim 17, wherein the deposition solution comprises a volumetric proportion of the aqueous hole-opening agent that is greater than a volumetric proportion of the fine particles of the binder resin.
